(19) United States
(12) Patent Application Publication
(10) Pub. No.: US 2025/0252384 A1
(43) Pub. Date: Aug. 7, 2025

(54) SYSTEM AND METHOD FOR GENERATING A TEXT-SUMMARY OF A MULTIPLE-SECTIONS TEXT-DOCUMENT THAT WAS CREATED VIA AN APPLICATION THAT IS RUNNING IN A CLOUD-BASED CONTACT CENTER FOR A TENANT

(71) Applicant: NICE LTD., Ra'anana (IL)

(72) Inventors: Rahul VYAS, Jodhpur (IN); Devinder LAMBA, Pune (IN); Abhijit MOKASHI, Pune (IN)

(21) Appl. No.: 18/433,525

(22) Filed: Feb. 6, 2024

(51) Int. Cl. G06Q 10/0639; G06Q 10/0631

(52) U.S. Cl. CPC G06Q 10/06398; G06Q 10/063112; G06Q 10/06395

(57) ABSTRACT

A computerized-method for generating a text-summary of a multiple-sections text-document that was created via an application that is running in a cloud-based CC for a tenant. The computerized-method includes: (i) operating a prompt-generator module to yield a prompt-text, the prompt-generator module includes: a. retrieving a rule of configuration of the text-summary of the multiple-sections text-document; b. fetching data related to the multiple-sections text-document, the data related to the multiple-sections text-document includes sections, and each section of the sections comprising questions and each question of the questions has a corresponding answer, and c. generating the prompt-text based on the rule of configuration and the data related to the multiple-sections text-document and the multiple-sections text-document; (ii) generating the text-summary by operating a GenAI with LLMs service to execute the prompt-text; and (iii) storing the text-summary in a summary-database to be used to operate actions for the tenant.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis and Artificial Intelligence (AI) and more specifically, to generation of a text-summary of a multiple-sections text-document that was created via an application that is running in a cloud-based contact center for a tenant.

### BACKGROUND

In contact centers, the interactions between each contact center agent and customers are recorded for quality evaluation purposes and agents performance measurements. These interactions are sent for quality evaluation to a quality assurance team which consists of evaluators. The evaluators while evaluating each interaction use an evaluation form that includes multiple sections, and each section consists of multiple questions. The sections generally represent the skill that is being evaluated and the question represents different aspect of the skills being evaluated. Questions may be of type radio button, checkboxes, multi-choice add text, YesNo, dropdown, and the like. A single evaluation form consists of a lot of text in the form of sections, questions, answers and sometimes evaluators give evaluators comment while completing the evaluation form. There may be multiple ways of providing comments, for example, comment on a question, comment on a section and overall comment on the entire evaluation.

Once the evaluators answer all the questions in the evaluation form, e.g., a multiple-sections text-document that was created via an application that is running in a cloud-based contact center, they submit the evaluation form which is then being analyzed and results into an evaluation score by the application. These quality evaluations include important insights, and a manager of a team of agents may spend time to read each evaluation and deduce from it an actionable item. Commonly, it may take about 15 to 20 minutes to read a single evaluation of one agent. Hence, it may require approximately 100 hours a month for the manager to look at each evaluation of each agent in the agents team which may not be practical or even possible and may result into the manager not inspecting each evaluation, inability to provide timely feedback and inadequate time for their important topics of one-on-one meetings.

Moreover, a monthly summary report of the agents team has to be generated which is also time consuming because it takes time to find trends and patterns from all the evaluations that have been generated during the month. Therefore, there is a need for a technical solution to improve the summarization of an evaluation and the summarization of multiple evaluations. There is a need for system and method for generating a text-summary of a multiple-sections text-document that was created via an application that is running in a cloud-based contact center for a tenant.

### SUMMARY

There is thus provided, in accordance with some embodiments of the present disclosure, a computerized-method for generating a text-summary of a multiple-sections text-document that was created via an application that is running in a cloud-based contact center for a tenant.

In accordance with some embodiments of the present disclosure, the computerized-method may include: (i) operating a prompt-generator module to yield a prompt-text. The prompt-generator module may include a. retrieving a rule of configuration of the text-summary of the multiple-sections text-document, from a summary-configuration database; b. fetching data related to the multiple-sections text-document from a database of the application. The data related to the multiple-sections text-document may include one or more sections. Each section of the one or more sections may include one or more questions and each question of the one or more questions has a corresponding answer; and c. generating the prompt-text based on the rule of configuration and the data related to the multiple-sections text-document and the multiple-sections text-document; (ii) generating the text-summary by operating a Generative Artificial Intelligence (GenAI) with Large Language Models (LLM) s service of a cloud GenAI with LLM service-provider to execute the prompt-text; and (iii) storing the text-summary in a summary-database to be used to operate one or more actions for the tenant.

Furthermore, in accordance with some embodiments of the present disclosure, the generating of the text-summary of the multiple-sections text-document may be operated upon receiving from a serverless streaming data service, a trigger event of completion of filling out the multiple-sections text-document.

Furthermore, in accordance with some embodiments of the present disclosure, the rule is one of: (i) default summary configuration; and (ii) tenant summary configuration.

Furthermore, in accordance with some embodiments of the present disclosure, the rule of configuration of the text-summary may include at least one of: (i) required features in the multiple-sections text-document; (ii) length of each section; (iii) one or more recipients of the text-summary; (iv) number of multiple-sections text-documents included in the text-summary; and (v) format in which the text-summary is sent to the one or more recipients. The prompt-generator module may generate the prompt-text based on the required features in the multiple-sections text-document by embedding each feature in a prompt-template.

Furthermore, in accordance with some embodiments of the present disclosure, the text-summary may be an evaluation summary and the multiple-sections text-document may be an evaluation form of performance of an agent during an interaction with a customer. The evaluation form has been created via a Quality Management (QM) application that is running as a service via the cloud-based CC for the tenant. The database is a QM database that is associated to the QM application.

Furthermore, in accordance with some embodiments of the present disclosure, the required features comprising at least one of: (i) length of summary of the text-summary; (ii) length of a summary of an interaction related to the evaluation form; (iii) length of summary of each section of the multiple-sections text-document; (iv) strength and improvements of the agent; (v) trends and patterns demonstrated by the agent in multiple-sections text-documents; (vi) training recommendations; and (vii) summary of suggestions given by an evaluator that filled out the evaluation form.

Furthermore, in accordance with some embodiments of the present disclosure, the prompt-generator module may be generating the prompt-text based on the required features in the multiple-sections text-document by embedding each feature in a prompt-template.

Furthermore, in accordance with some embodiments of the present disclosure, the computerized-method may further include: (i) operating a configuration service to receive the rule for configuration of the text-summary from the tenant via a summary configuration User Interface (UI); and (ii) storing the rule for configuration of the text-summary in the summary-configuration database.

Furthermore, in accordance with some embodiments of the present disclosure, the multiple-sections text-document may be a combination of more than one text-document. The rule for configuration of the text-summary may further include: (i) multiple text-documents in the combination of more than one text-document; and (ii) related entity of the combination of the more than one text-documents and a period of time thereof. The related entity is one of: a. agent; b. team of agents; and c. organization unit that includes multiple teams of agents.

Furthermore, in accordance with some embodiments of the present disclosure, when the rule for configuration of the text-summary includes multiple text-documents in the combination of more than one text-document and related entity of the combination of more than one text-document and a period of time, the computerized-method may further include: (i) generating an extract of the text-summary by operating the GenAI with LLMs service to execute an abbreviation-prompt with the text-summary to yield an abbreviated-text-summary; (ii) storing the abbreviated-text-summary in the summary-database; and (iii) operating a scheduler module to generate a periodic-text-summary between the period of time.

Furthermore, in accordance with some embodiments of the present disclosure, when the rule for configuration of the text-summary comprising multiple text-documents in the combination of more than one text-document and related entity of the combination of more than one text-document and a period of time, said computerized-method further comprising: (i) generating an extract of the text-summary by operating the GenAI with LLMs service to execute an abbreviation-prompt with the multiple-sections text-document to yield an abbreviated-text-summary; (ii) storing the abbreviated-text-summary in the summary-database; and (iii) operating a scheduler module to generate a periodic-text-summary between the period of time.

Furthermore, in accordance with some embodiments of the present disclosure, an action of the one or more actions that is operated may be sending the text-summary via one or more delivery channels by operating a notification delivery service, and the text summary may be sent to the one or more recipients of the text-summary.

Furthermore, in accordance with some embodiments of the present disclosure, an action of the one or more actions that is operated may be running an automated coaching distribution module, said automated coaching distribution module comprising creating a new coaching session to the agent, via a coaching management system, based on the training recommendations in the text-summary.

Furthermore, in accordance with some embodiments of the present disclosure, the scheduler module may include: a. retrieving the rule of configuration of the text-summary of the multiple-sections text-document, from the summary-configuration database, every preconfigured period; when the period of time in the rule has reached b. retrieving one or more abbreviated-text-summaries of the related entity during the period of time from the summary-database; c. generating the periodic-text-summary by operating the GenAI with LLMs service to execute a periodic-prompt-text; and d. storing the periodic-text-summary in the summary-database to be used to operate the one or more actions. The periodic-prompt-text is generated based on the one or more abbreviated-text-summaries in a periodic-prompt-template.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1B schematically illustrate a high-level diagram of a computerized-system for generating a text-summary of a multiple-sections text-document that was created via an application that is running in a cloud-based Contact Center (CC) for a tenant, in accordance with some embodiments of the present invention;

FIGS. 2A-2B schematically illustrate a high-level diagram of a computerized-method for generating a text-summary of a multiple-sections text-document that was created via an application that is running in a cloud-based Contact Center (CC) for a tenant, in accordance with some embodiments of the present invention;

FIGS. 3A-3D schematically illustrate high-level flowchart of for generating a text-summary of a multiple-sections text-document that was created via an application that is running in a cloud-based Contact Center for a tenant, in accordance with some embodiments of the present invention;

FIGS. 4A-4D schematically illustrate high-level flowchart of for generating a text-summary of a multiple-sections text-document that was created via an application that is running in a cloud-based Contact Center for a tenant, in accordance with some embodiments of the present invention;

FIGS. 5A-5B schematically illustrate high-level flowchart of creating prompt and executing an evaluation summary, in accordance with some embodiments of the present invention;

FIG. 6 is an example of summaries of multiple evaluations for a combination of level and schedule settings, in accordance with some embodiments of the present invention;

FIG. 7 is an example of an SQL query to collect the abbreviated evaluation summary from the summary database, in accordance with some embodiments of the present invention;

FIGS. 8A-8E are examples of summary of evaluation LLM prompt, in accordance with some embodiments of the present invention;

FIG. 9 is an example of a summary of a single evaluation LLM prompt result, in accordance with some embodiments of the present invention;

FIG. 10 is an example of an abbreviated summary of a single evaluation LLM prompt result, in accordance with some embodiments of the present invention;

FIG. 11 is an example of a summary of multiple evaluations LLM prompt result, in accordance with some embodiments of the present invention;

FIG. 12 is an example of a User Interface (UI) for summary configuration, in accordance with some embodiments of the present invention;

FIG. 13 is an example of a temporary variable “availableCoachings”, in accordance with some embodiments of the present invention;

FIG. 14 is an example of a temporary variable “recommendations”, in accordance with some embodiments of the present invention; and

FIG. 15 is an example of a temporary variable mainCoachingPrompt, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In contact centers, an evaluation is a process of rating how well an agent handled an interaction with a customer of the contact center via an application. The process is performed by listening to a recording of the interaction and answering an evaluation form that includes multiple sections. Each section includes questions which are used to evaluate specific aspect of agent's skills. Each question has a score associated to it, thus when the evaluator is answering all the questions, the overall score for the evaluation form may be generated by the application. During the evaluations the evaluator can also provide additional inputs in the form of comments in free texts.

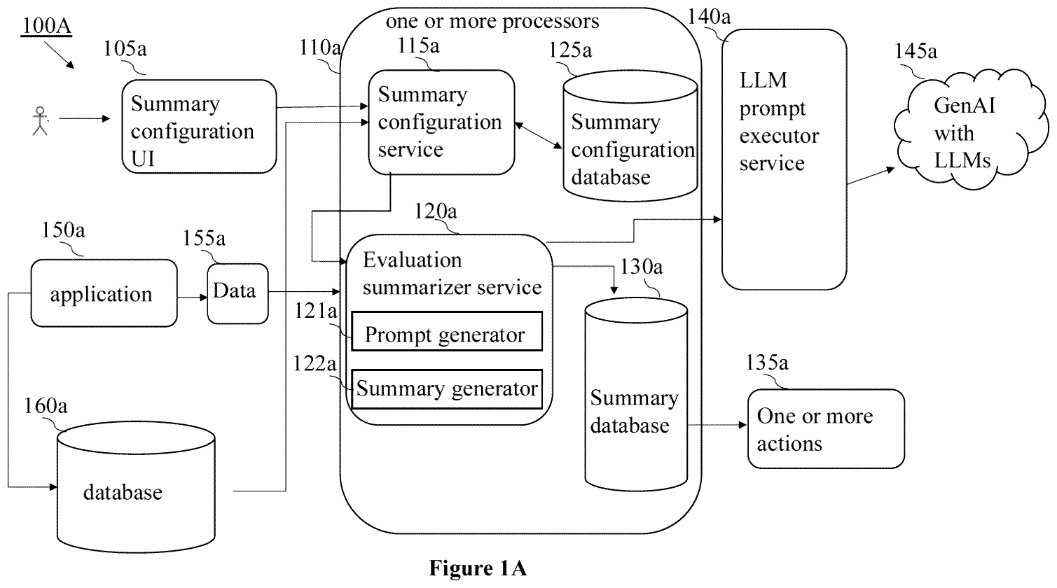

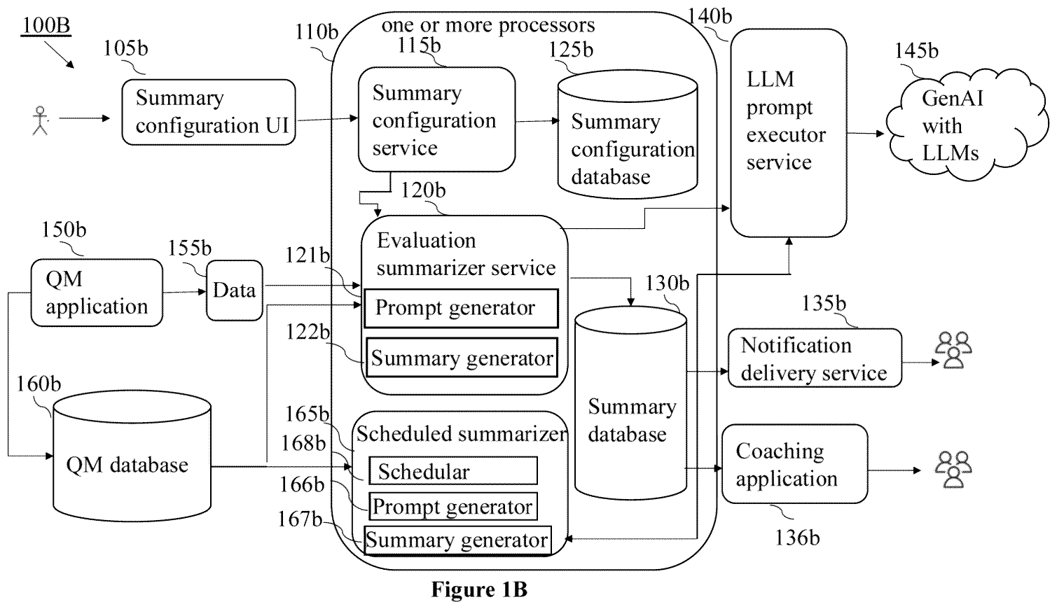

FIG. 1A schematically illustrates a high-level diagram of a computerized-system 100A for generating a text-summary of a multiple-sections text-document that was created via an application that is running in a cloud-based Contact Center (CC) for a tenant, in accordance with some embodiments of the present invention.

According to some embodiments of the present disclosure, system 100A may generate a text-summary of a multiple-sections text-document that was created via an application, such as application 150a, that is running in a cloud-based Contact Center (CC) for a tenant.

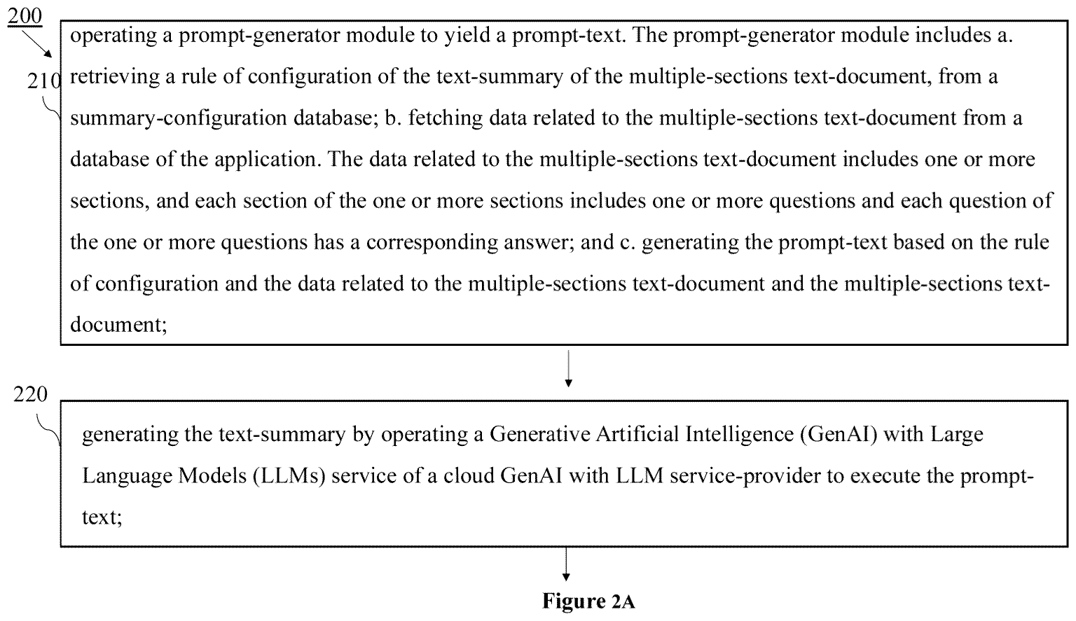

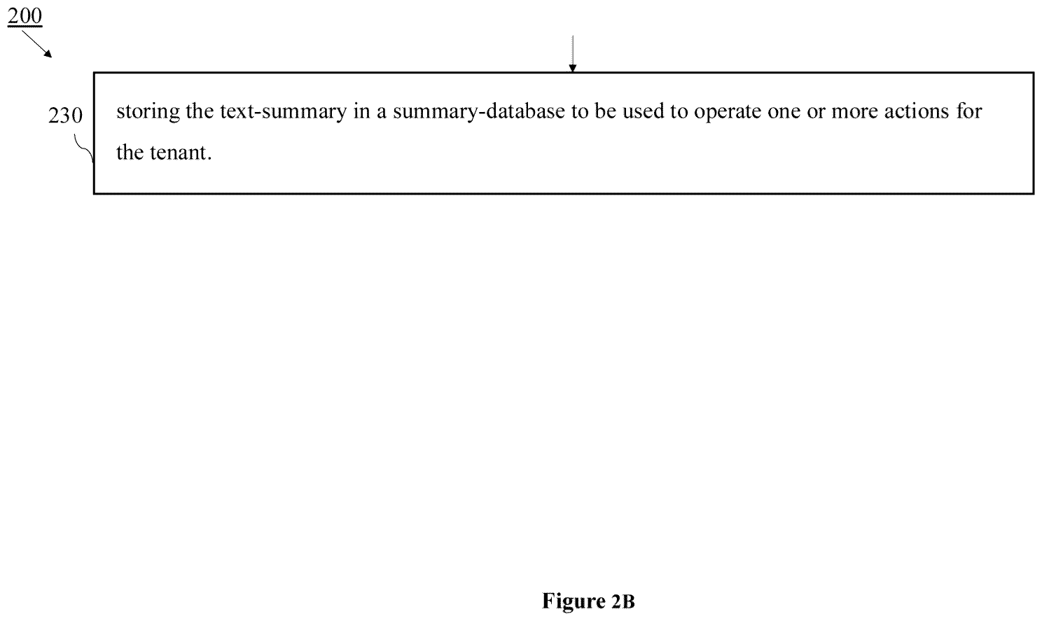

According to some embodiments of the present disclosure, system 100A may include one or more processors 110a which may implement a summarization module, such as computerized-method for generating a text-summary of a multiple-sections text-document that was created via an application that is running in a cloud-based Contact Center (CC) for a tenant 200 in FIGS. 2A-2B.

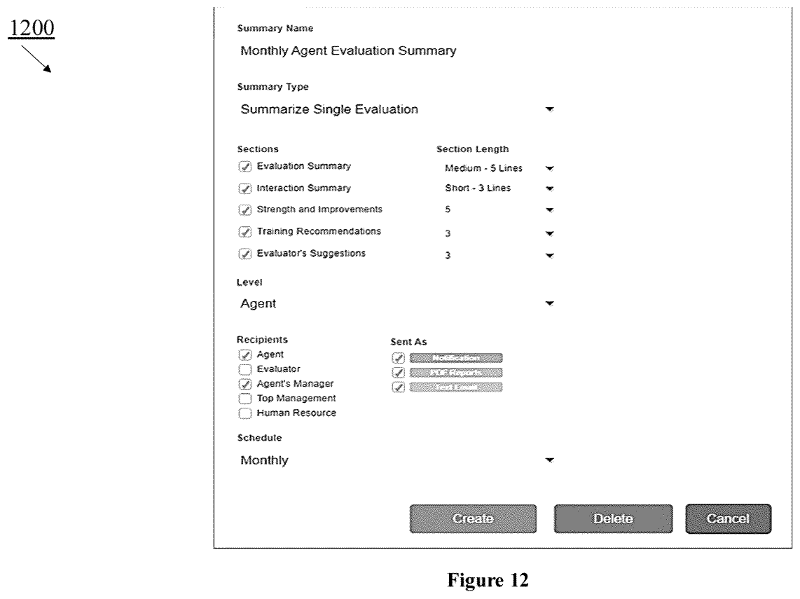

According to some embodiments of the present disclosure, the text-summary may be configured by a user via an interface, such as summary configuration User Interface (UI) 105a. The summary configuration UI 105a may be implemented as a web UI page and may be used to configure the required summaries, sections in the multiple-sections text-document that should be included in the summary, the length of each section, recipients of the summary and the levels at which the text-summary may be generated, such as agent or team or organizational unit. The pages of the summary configuration UI 105a may be available as hosted website using angular technology. When the user may access this page the UI pages may be loaded in the user's web browser and run within the browser. The summary configuration User Interface (UI) 105a may be for example, as shown in FIG. 12.

According to some embodiments of the present disclosure, the summary configuration UI 105a may store and manage the summary configurations by receiving the configuration of the text-summary in the form of user inputs and performing required input validations. The summary configuration UI 105a may send the received configuration to a summary configuration service 115a, via a Representational State Transfer (REST) Application Programming Interface (API) call. The summary configuration may be stored as a rule of configuration of the text-summary in a database, such as summary configuration database 125a.

According to some embodiments of the present disclosure, the summary configuration service 115a may be implemented as a microservice that exposes Rest APIs to read, create, update, and delete the summary configuration. This service may be implemented using Java Spring Boot technology. The microservice may run in a cloud computing environment for example, on Docker containers which are deployed on Amazon Web Services (AWS) Elastic Container Service (ECS) or on any computer which has Java Runtime Environment installed.

According to some embodiments of the present disclosure, the summary configuration service 115a may support the rule of configuration of the text-summary of the multiple-sections text-document for each text-summary. Summary type, which may indicate if the user is configuring the text-summary to be generated for each single multiple-sections text-document, e.g., evaluation form or the text-summary to be generated for multiple evaluation forms.

According to some embodiments of the present disclosure, the rule of configuration of the text-summary may include at least one of: (i) required features in the multiple-sections text-document; (ii) length of each section; (iii) one or more recipients of the text-summary; (iv) number of multiple-sections text-documents included in the text-summary; and (v) format in which the text-summary is sent to the one or more recipients. The rule of configuration of the text-summary may be stored in a database, such as summary-configuration database 125a. The summary configuration database 125a may store rule of configuration that may include sections, section length, recipients, level and schedule.

According to some embodiments of the present disclosure, the summary-configuration database 125a may be implemented in any type of storage, such as a Structured Query Language (SQL) database that stores the data in the form of SQL tables. The summary-configuration database 125a may run on a global-scale relational database service built for the cloud, such as AWS Aurora Service, or any computer which has required SQL database installed, such as MySQL, Postgres SQL, MariaDB. Other types of storage may be files, NoSQL database, Columnar Database etc.

According to some embodiments of the present disclosure, the multiple-sections text-document may be a combination of more than one text-document when the rule of configuration of the text-summary may include the feature level and period of time. The level may be used to define the entity for which the text-summary is generated, e.g., at what level the text-summary should be generated. For example, a monthly agent summary or monthly team of agents.

According to some embodiments of the present disclosure, the rule of configuration of the text-summary may include a feature to indicate the format in which the text-summary may be sent to the recipients. For example, the text-summary may be sent as a notification with a link to the text-summary within the application or Portable Document Format (PDF) as an attachment or textual summary in an email or any other format.

According to some embodiments of the present disclosure, the text-summary of the multiple-sections text-document may be generated upon receiving from a data service 155a, such as serverless streaming data service, a trigger event of completion of filling out the multiple-sections text-document. An evaluation summarizer service 120a may be implemented as a micro service that may summarize a single multiple-sections text-document. This service may be implemented by using Java Spring Boot technology.

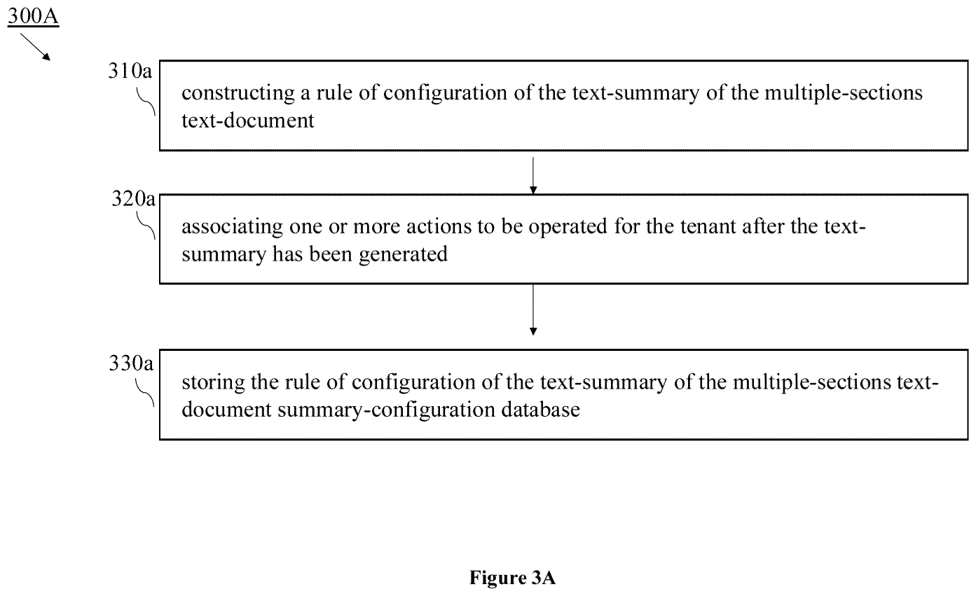

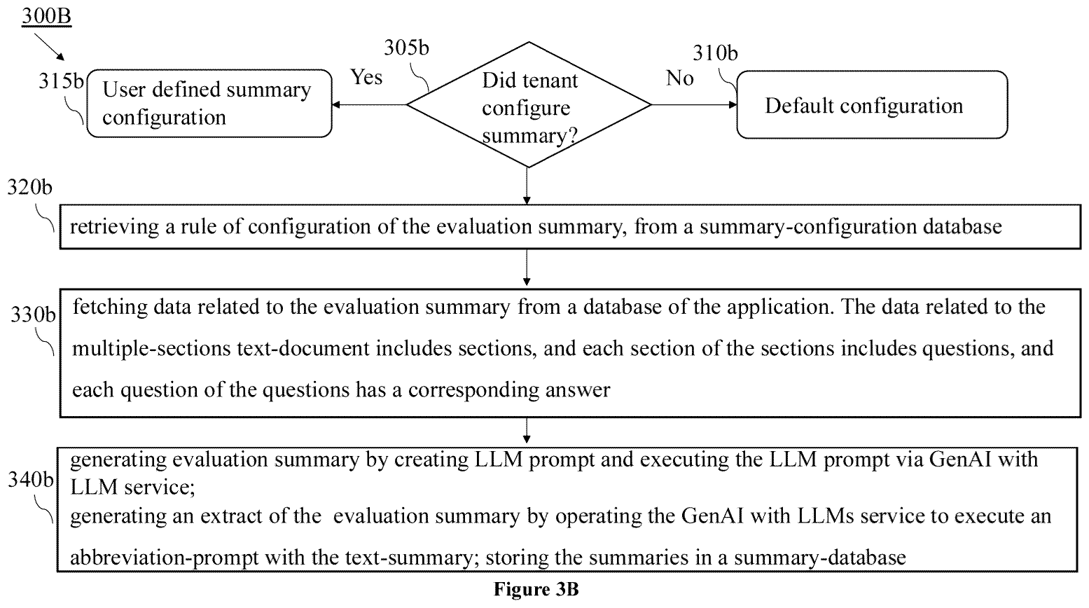

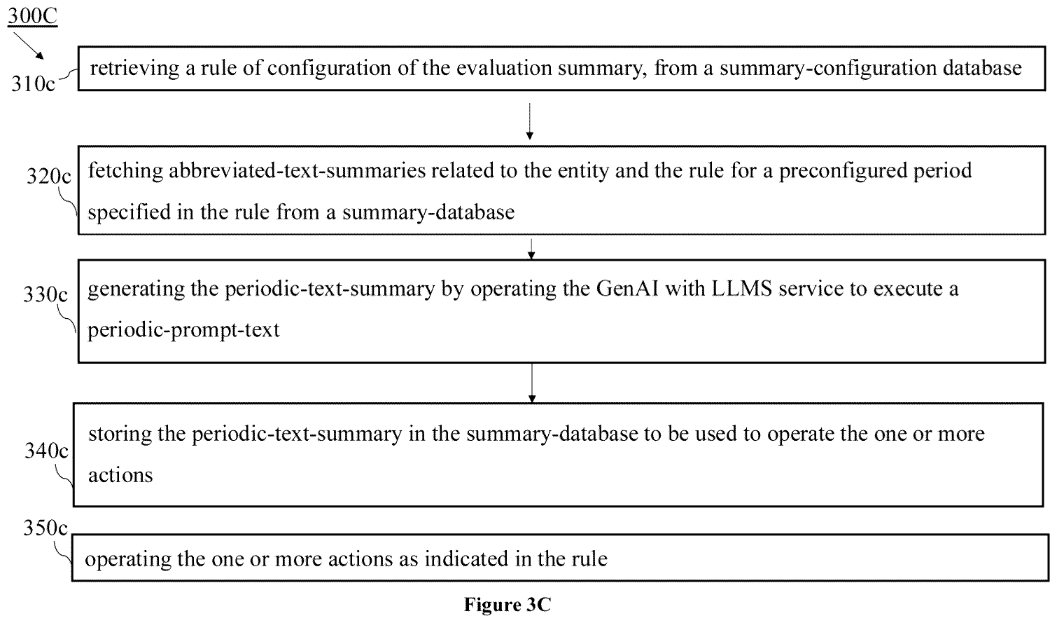

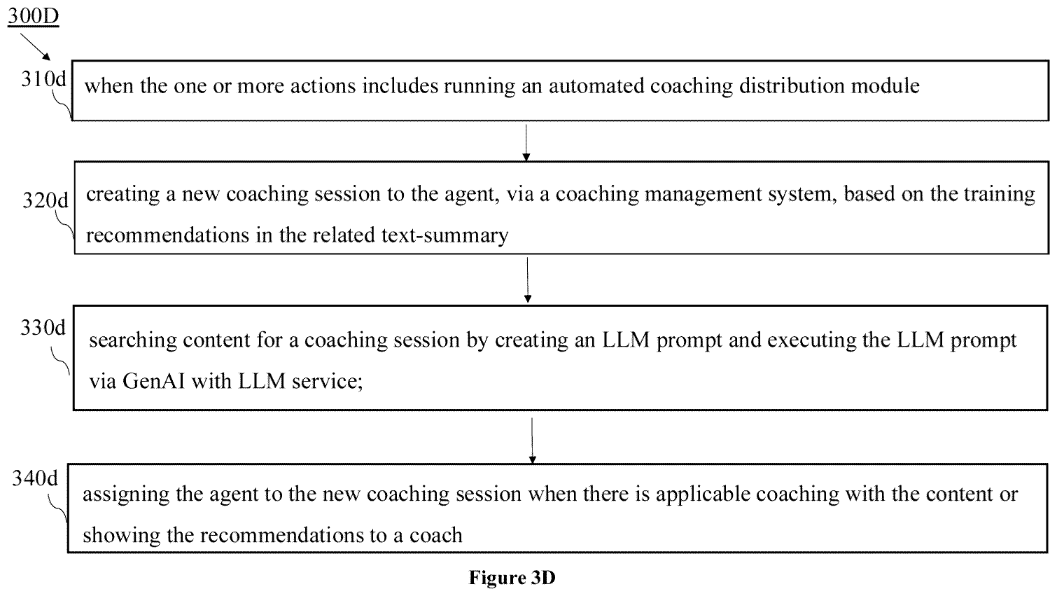

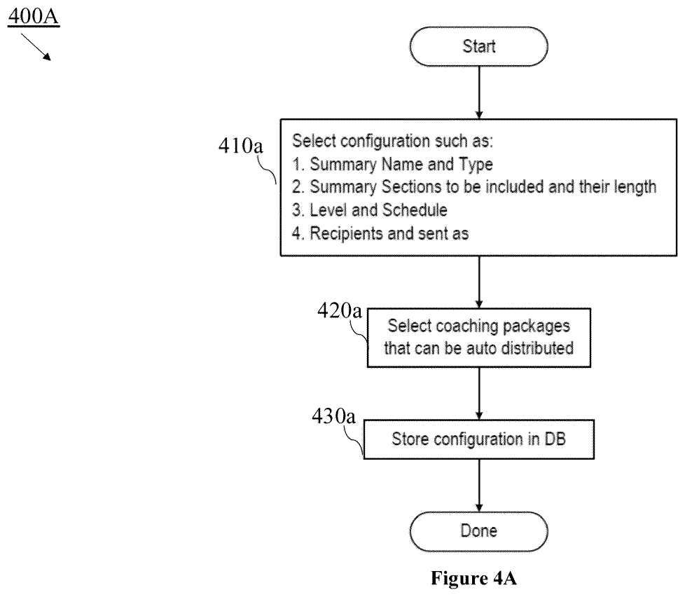

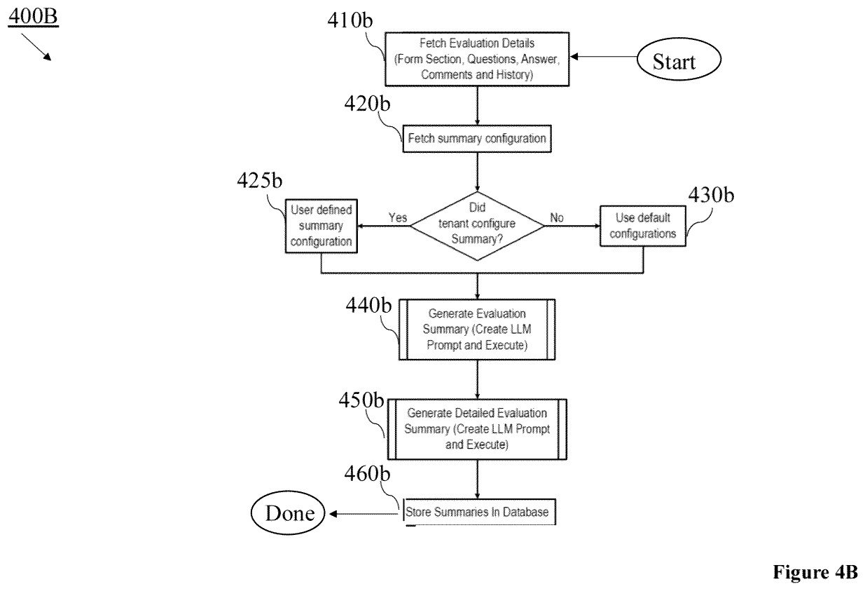

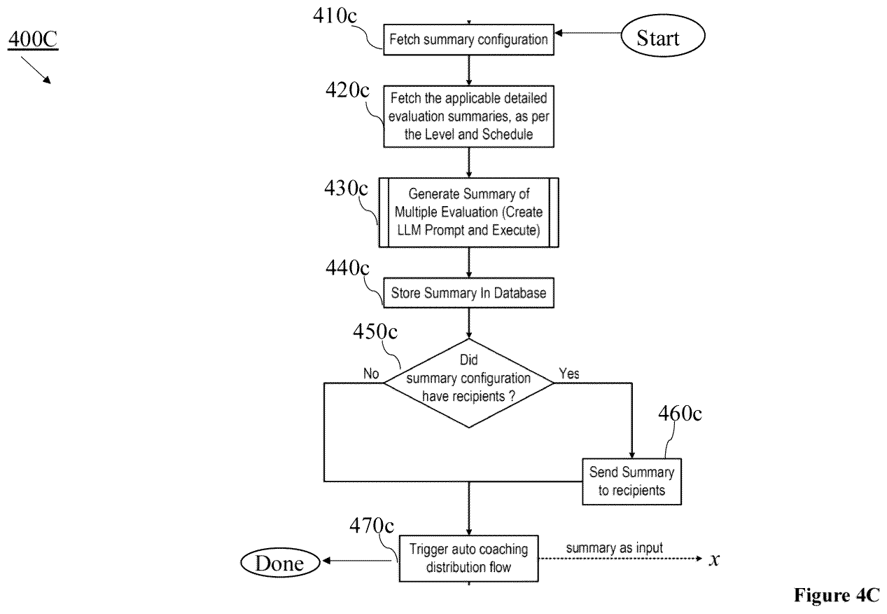

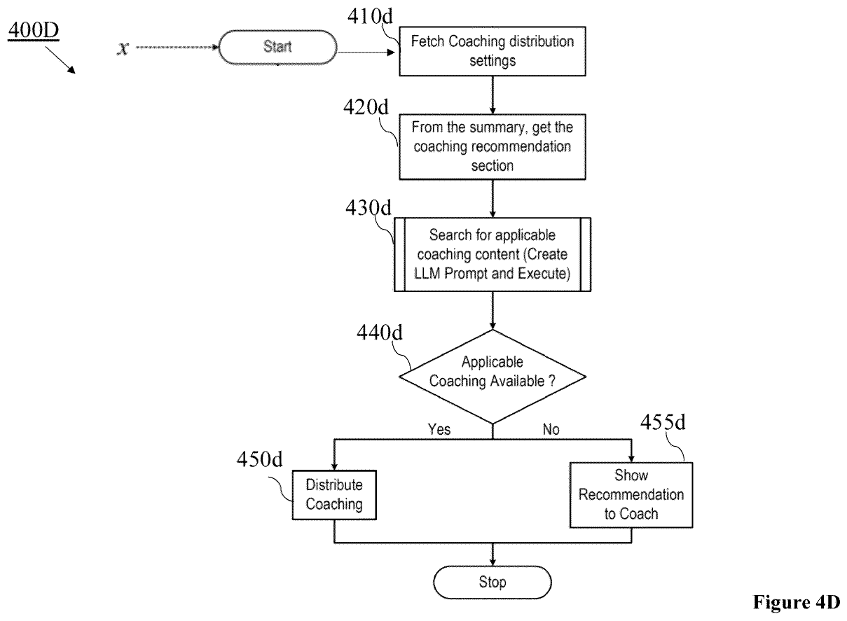

According to some embodiments of the present disclosure, the evaluation summarizer service 120a may receive the event of completion from the data service 155a, such as Kinesis Stream. Upon receiving the event of completion, the evaluation summarizer service 120a may start the summarization process, for example as shown in FIG. 3B and as shown in FIG. 4B.

According to some embodiments of the present disclosure, the evaluation summarizer service 120a may have two modules prompt generator module 121a and summary generator module 122a. The summary generator module 122a may gather all the required data to be fed to the prompt generator module 121a. Gathering all the required data by the summary generator module 122a may include retrieving the rule of configuration of the text-summary of the multiple-sections text-document, from the summary-configuration database 125a by fetching the summary configuration from summary configuration service 115a. The summary generator module 122a may also fetch the data related to the multiple-sections text-document from the application database 160a.

According to some embodiments of the present disclosure, the summary generator module 122a may invoke the prompt generator module 121a with the collected data to generate the prompt-text based on the rule of configuration and the data related to the multiple-sections text-document and the multiple-sections text-document and then may send the generated prompt to an LLM Prompt executor service 140a. The LLM, i.e., Large Language AI Models may be Generative Pre-Trained Transformer (GPT), Bidirectional Encoder Representations from Transformers (BERT), Pathways Language Model (PaLM) and the like.

According to some embodiments of the present disclosure, the LLM prompt executor service 140a may be implemented by a micro service that exposes REST APIs that allow execution of LLM prompts and may be implemented using Java Spring Boot technology. The LLM prompt executor service 140a may execute the LLM Prompt by calling the appropriate APIs of the Cloud LLM service-provider. The LLM prompt executor service 140a integrates with the Cloud LLM service-provider via APIs and handles all the operational aspects of the integration. The LLM prompt executor service 140a may be implemented as a micro service in a cloud computing environment and for example may run on Docker containers which are deployed on AWS ECS service, or on any computer which has Java Runtime Environment installed.

According to some embodiments of the present disclosure, the text-summary may be generated by operating a Generative Artificial Intelligence (GenAI) with Large Language Models (LLM) s service 145a of a cloud GenAI with LLM service-provider to execute the prompt-text.

According to some embodiments of the present disclosure, the evaluation summarizer service 120a may store the generated text-summary in a database, such as summary database 130a. the evaluation summarizer service 120a may generate two types of summary, the text-summary which is a final output and an abbreviated-text-summary, which is an intermediate output that may be required by a scheduled summarizer service, such as scheduled summarizer service 165b, in FIG. 1B. The abbreviated-text-summary may be referred to as detailed evaluation summary.

According to some embodiments of the present disclosure, the prompt generator module 121a may generate the adequate LLM prompt for the text-summary based on the retrieved rule of configuration of the text-summary of the multiple-sections text-document. It uses the rule, i.e., the summary configuration to determine which summery sections to be included in the prompt-text and to embed the collected data in the prompt template. The final output of the prompt generator module 121a is the LLM prompt-text.

According to some embodiments of the present disclosure, the summary database 130a may be implemented by a micro service in a cloud computing environment, for example, on Docker containers which are deployed on AWS ECS service or any computer which has Java Runtime Environment installed.

According to some embodiments of the present disclosure, the summary database 130a may be implemented as an SQL database that stores the data in the form of SQL tables. The summary database 130a may run in a cloud computing environment, e.g., AWS Aurora Service, or any computer which has required SQL database installed such as MySQL, Postgres SQL, MariaDB. The summary database 130a may be implemented in any other type of storage, such as files, NoSQL database, Columnar Database etc.

According to some embodiments of the present disclosure, the text-summary which may be stored in a summary database 130a may be used to operate one or more actions for the tenant. An action of the one or more actions may be sending the text-summary via one or more delivery channels by operating a notification delivery service, e.g., notification delivery service 135b, in FIG. 1B to the one or more recipients of the text-summary a indicated in the rule of configuration.

According to some embodiments of the present disclosure, an action of the one or more actions may be running an automated coaching distribution module, which may include creating a new coaching session to an agent, via a coaching management system, such as coaching application 136b in FIG. 1B based on the training recommendations in the generated text-summary.

FIG. 1B schematically illustrates a high-level diagram of a computerized-system 100B for generating a text-summary of a multiple-sections text-document that was created via an application that is running in a cloud-based contact center for a tenant, in accordance with some embodiments of the present invention.

According to some embodiments of the present disclosure, system 100B may include all the components as in system 100A.

According to some embodiments of the present disclosure, system 100B may include one or more processors 110b which may implement a summarization module, such as computerized-method for generating a text-summary of a multiple-sections text-document that was created via an application that is running in a cloud-based Contact Center (CC) for a tenant 200 in FIGS. 2A-2B.

According to some embodiments of the present disclosure, the text-summary that may be generated in system 100B may be for example, an evaluation summary and the multiple-sections text-document may be an evaluation form of performance of an agent during an interaction with a customer. The evaluation form may have been created via a Quality Management (QM) application 150b that is running as a service via the cloud-based CC for the tenant, and stored in a database of the application such as QM database 160b that is associated to the QM application 150b.

According to some embodiments of the present disclosure, the interactions for evaluation by the evaluator may be also text interactions, such as email, social media platform chats, such as Facebook®, Twitter®, Instagram®, Whatsapp® and the like.

According to some embodiments of the present disclosure, the QM application is an application that provides required functionality for quality management for a contact center, such as agent interaction evaluation, coaching, evaluator calibrations and the like. The agent interaction evaluation functionality allows the interactions to be recorded, and the evaluator can review the interaction by either listening to the recording or reading the text of the interaction and generate an evaluation score by answering questions in the evaluation form. The evaluation form consists of questions in multiple sections which are used to evaluate specific aspect of agent's skills. Multiple questions are grouped into a single evaluation form section. There can be various types of questions such as single choice, multi choice, text, long text. Each question has a score associated to it, thus when the evaluator is answering all the questions, the overall score for the evaluation form may be generated. The score is regarded as an evaluation score while evaluating any individual agent interaction. During the evaluations the evaluator can also provide additional inputs in the form of comments. The comments are free texts that evaluator can enter within the evaluation from.

According to some embodiments of the present disclosure, the evaluation data, e.g., evaluation form, sections, questions, answers comments and history may be stored in the database, such as QM database 160b. When, an evaluator completes an evaluation form by answering all the questions, the QM application generates an event on the data 155b, such as Kinesis Stream, which has all the required data of evaluation and is further consumed by an evaluator summarizer service 120b. The application may run in a cloud computing environment, such as AWS cloud and built using various cloud services such as ECS, EC2, Arora SQL or use non cloud services, such as commodity computers, Docker, Kubernetes, files system, NoSQL database, Columnar Database, and the like.

According to some embodiments of the present disclosure, the required features in the rule of configuration of the text-summary may include at least one of: (i) length of summary of the text-summary; (ii) length of a summary of an interaction related to the evaluation form; (iii) length of summary of each section of the multiple-sections text-document; (iv) strength and improvements of the agent; (v) trends and patterns demonstrated by the agent in multiple-sections text-documents; (vi) training recommendations; and (vii) summary of suggestions given by an evaluator that filled out the evaluation form.

According to some embodiments of the present disclosure, the QM database 160b may be implemented as SQL database that stores the data in the form of SQL tables. It may store evaluation forms in the various entities i.e., evaluation form, sections, and questions. It also stores the answers and comments provided by the evaluator in the evaluation form. The QM database may run in a cloud computing environment, e.g., on AWS Aurora Service or it can run on any computer which has required SQL database installed such as MySQL, Postgres SQL, MariaDB.

According to some embodiments of the present disclosure, when the rule for configuration of the text-summary may include multiple text-documents in the combination of more than one text-document and related entity of the combination of more than one text-document and a period of time, an extract of the text-summary may be generated by the evaluation summarizer service 120b by operating the GenAI with LLMs service 145b to execute an abbreviation-prompt with the text-summary to yield an abbreviated-text-summary. The abbreviated-text-summary may be stored in the summary-database 130b and a scheduler module, such as scheduled summarizer service 165b may be operated to generate a periodic-text-summary between the period of time. The summary-database 130b may store text-summaries, abbreviated-text-summaries, and the periodic-text-summaries.

According to some embodiments of the present disclosure, the scheduled summarizer service 165b may be implemented as a micro service to summarize multiple text-summaries. The service may be implemented by using Java Spring Boot technology.

According to some embodiments of the present disclosure, the scheduled summarizer service 165b may run on the schedule that has been defined by the user in the rule for configuration of the text-summary, e.g., summary configuration, and may start the summarization process, for example as shown in FIG. 3C and as shown in FIG. 4C.

According to some embodiments of the present disclosure, the scheduled summarizer service 165b may operate the scheduler module 168b to retrieve the rule of configuration of the text-summary of the multiple-sections text-document, from the summary-configuration database 125b via the summary configuration service 115b, every preconfigured period and to monitor when the period of time in the rule has reached. When the period of time in the rule has reached, the scheduler module 168b may trigger a timer task to start the summarization process by invoking the summary generator module 167b. The summary generator module 167b may retrieve one or more abbreviated-text-summaries of the related entity during the period of time from the summary-database 130b. The related entity may be an agent, a team of agents and multiple teams of agents that belong to a unit of the organization.

According to some embodiments of the present disclosure, the periodic-text-summary may be generated by operating the GenAI with LLMs service 145b to execute a periodic-prompt-text. The periodic-prompt-text has been generated by the prompt generator module 166b. Based on the defined frequency, e.g., the period of time in the rule, the scheduled summarizer 165b may generate a periodic summary, periodic-text-summary for the entity, for example, daily agent summary, daily team summary, monthly agent summary and the like.

According to some embodiments of the present disclosure, the prompt generator module 166b may generate the periodic-prompt-text based on the one or more abbreviated-text-summaries which may be embedded in a periodic-prompt-template. Once the text-summary has been generated it may be stored in the summary database 130b.

According to some embodiments of the present disclosure, the text-summary which may be stored in a summary database 130b may be used to operate one or more actions for the tenant. An action of the one or more actions may be sending the text-summary via one or more delivery channels by operating a notification delivery service, e.g., notification delivery service 135b, to the one or more recipients of the text-summary a indicated in the rule of configuration.

According to some embodiments of the present disclosure, the notification delivery service 135b may be implemented as a micro service that exposes REST APIs that allow delivery of notifications via various delivery channels, such as in application notification, email, and Short Message Service (SMS) and may be using Java Spring Boot technology, or any other service that offers ability to send notification via email. The micro service may run in a cloud computing environment, e.g., run on Docker containers which are deployed on AWS ECS service, or on any computer which has Java Runtime Environment installed.

According to some embodiments of the present disclosure, an action of the one or more actions may be running an automated coaching distribution module, which may include creating a new coaching session to an agent, via a coaching management system, such as coaching application 136b based on the training recommendations in the generated text-summary.

According to some embodiments of the present disclosure, the coaching application 136b may be an application that is used for contact center coaching. It exposes UI and API to facilitate coaching use cases. This service may be using Java Spring Boot technology. The coaching application 136b is used by contact center coaches to create coaching session and coaching packages for agents. Agents also use this application to go through the coaching packages and complete the coaching sessions assigned to them.

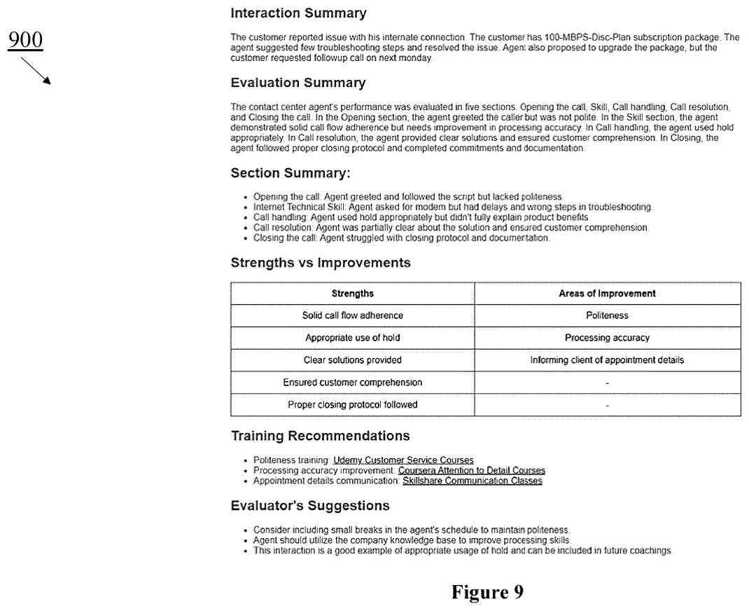

According to some embodiments of the present disclosure, a contact center coach may create a coaching session with the required coaching content and assign it to the respective agent. The coaching application 136b may operate an automated coaching distribution module. This module may be configured to fetch the coaching recommendation generated as part of the evaluation summaries and present it to the coach that is creating the coaching session. The coaching recommendation that has been generated as part of the evaluation summary may be under the training recommendations section in the evaluation summary, for example as shown in FIG. 9. Thus, the contact center coach doesn't have to go through the long process of manually finding coaching opportunities by manually reading all the evaluation forms. The training recommendations which are part of the evaluation summary may be used to create the required coaching sessions and assign them to the agents.

According to some embodiments of the present disclosure, the operated automated coaching distribution module may be configured to assign a coaching session to the agent based on the training recommendations in the evaluation summary. The coaching session may be assigned based on preselected coaching packages for each training recommendation in the summary evaluation.

According to some embodiments of the present disclosure, the coaching application 136b may run in a cloud computing environment such as AWS cloud and may use various cloud services, such as ECS, EC2, Arora SQL. Optionally, the coaching application 136b may be implemented by non cloud services, such as commodity computers, Docker, Kubernetes, files system, NoSQL database, Columnar Database, and the like.

According to some embodiments of the present disclosure, the evaluation summarizer service 120b may have two modules prompt generator module 121b and summary generator module 122b. The summary generator module 122b may gather all the required data to be fed to the prompt generator module 121b. Gathering all the required data by the summary generator module 122b may include retrieving the rule of configuration of the text-summary of the multiple-sections text-document, from the summary-configuration database 125b by fetching the summary configuration from summary configuration service 115b. The summary generator module 122b may also fetch the data, such as evaluation data e.g., forms, sections, questions, answers, comments, and history, from the QM application database 160b. The evaluation history includes any changes that have been performed to the evaluation form as part of the evaluation process. It may include information such as: when evaluator submitted the evaluation, what was the score at the time of submission, did the agent challenged/disputed/disagree the evaluation? If yes, then who resolved the dispute, and what was the score after the dispute resolution, and the like. This history information can also be used in the evaluation summary generation process.

FIGS. 2A-2B schematically illustrates a high-level diagram of a computerized-method for generating a text-summary of a multiple-sections text-document that was created via an application that is running in a cloud-based Contact Center (CC) for a tenant, in accordance with some embodiments of the present invention.

According to some embodiments of the present disclosure, operation 210 comprising operating a prompt-generator module to yield a prompt-text. The prompt-generator module includes a. retrieving a rule of configuration of the text-summary of the multiple-sections text-document, from a summary-configuration database; b. fetching data related to the multiple-sections text-document from a database of the application. The data related to the multiple-sections text-document includes one or more sections, and each section of the one or more sections includes one or more questions and each question of the one or more questions has a corresponding answer; and c. generating the prompt-text based on the rule of configuration and the data related to the multiple-sections text-document and the multiple-sections text-document.

According to some embodiments of the present disclosure, operation 220 comprising generating the text-summary by operating a Generative Artificial Intelligence (GenAI) with Large Language Models (LLMs) service of a cloud GenAI with LLM service-provider to execute the prompt-text.

According to some embodiments of the present disclosure, operation 230 comprising storing the text-summary in a summary-database to be used to operate one or more actions for the tenant.

FIG. 3A schematically illustrates high-level flowchart 300A of configuration summary in generating a text-summary of a multiple-sections text-document that was created via an application that is running in a cloud-based contact center for a tenant, in accordance with some embodiments of the present invention.

According to some embodiments of the present disclosure, in a system, such as system 100A in FIG. 1A and such as system 100B in FIG. 1B, constructing a rule of configuration of the text-summary of the multiple-sections text-document 310a, e.g., configuration summary, via a UI, such as summary configuration UI 105a in FIG. 1A, and such as summary configuration UI 105b in FIG. 1B and associating one or more actions to be operated for the tenant after the text-summary has been generated 320a.

According to some embodiments of the present disclosure, for example, the one or more actions may be sending the text-summary via one or more delivery channels by operating a notification delivery service, and wherein the text summary is sent to the one or more recipients of the text-summary.

According to some embodiments of the present disclosure, in another example, the one or more actions may be running an automated coaching distribution module, said automated coaching distribution module comprising creating a new coaching session to the agent, via a coaching management system, based on the training recommendations in the text-summary.

FIG. 3B schematically illustrates high-level flowchart 300B of generating a summary of single evaluation in generating a text-summary of a multiple-sections text-document that was created via an application that is running in a cloud-based contact center for a tenant, in accordance with some embodiments of the present invention.

According to some embodiments of the present disclosure, the generating of a summary single evaluation may begin with checking if the tenant configured the summary 305b. When the tenant didn't configure the summary then default configuration 310b may be used. When the tenant has configured the summary then the user defined summary configuration 315b may be used.

According to some embodiments of the present disclosure, retrieving a rule of configuration of the evaluation summary, from a summary-configuration database 320b and then fetching data related to the evaluation summary from a database of the application. The data related to the multiple-sections text-document includes sections, and each section of the sections includes questions, and each question of the questions has a corresponding answer 330b.

According to some embodiments of the present disclosure, generating evaluation summary by creating LLM prompt and executing the LLM prompt via GenAI with LLM service 340b and optionally, generating an extract of the evaluation summary by operating the GenAI with LLMs service to execute an abbreviation-prompt with the text-summary; storing the summaries in a summary-database 340b.

FIG. 3C schematically illustrates high-level flowchart 300C of generating a summary of multiple evaluation in generating a text-summary of a multiple-sections text-document that was created via an application that is running in a cloud-based Contact Center for a tenant, in accordance with some embodiments of the present invention.

According to some embodiments of the present disclosure, retrieving a rule of configuration of the evaluation summary, from a summary-configuration database 310c and then fetching abbreviated-text-summaries related to the entity and the rule for a preconfigured period specified in the rule from a summary-database 320c.

According to some embodiments of the present disclosure, generating the periodic-text-summary by operating the GenAI with LLMS service to execute a periodic-prompt-text 330c.

According to some embodiments of the present disclosure, storing the periodic-text-summary in the summary-database to be used to operate the one or more actions 340c and operating the one or more actions as indicated in the rule 350c.

FIG. 3D schematically illustrates high-level flowchart 300D of auto distribution of a coaching session based on evaluation summary in generate summary of multiple evaluation in generating a text-summary of a multiple-sections text-document that was created via an application that is running in a cloud-based Contact Center for a tenant, in accordance with some embodiments of the present invention.

According to some embodiments of the present disclosure, when the one or more actions includes running an automated coaching distribution module 310d.

According to some embodiments of the present disclosure, creating a new coaching session to the agent, via a coaching management system, based on the training recommendations in the related text-summary 320d.

According to some embodiments of the present disclosure, searching content for a coaching session by creating an LLM prompt and executing the LLM prompt via GenAI with LLM service 330d.

According to some embodiments of the present disclosure, assigning the agent to the new coaching session when there is applicable coaching with the content or showing the recommendations to a coach 340d.

FIG. 4A schematically illustrates high-level flowchart 400A of configuration summary in generating a text-summary of a multiple-sections text-document that was created via an application that is running in a cloud-based Contact Center for a tenant, in accordance with some embodiments of the present invention.

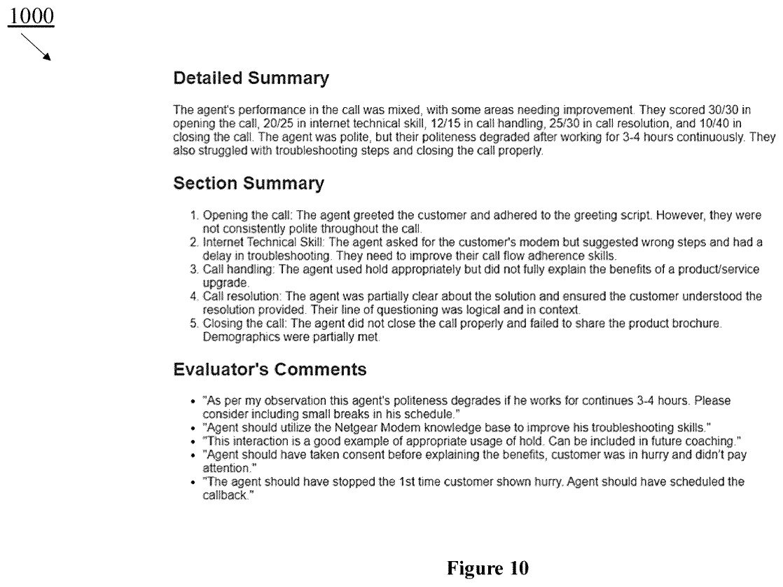

According to some embodiments of the present disclosure, a rule of configuration of the text-summary of the multiple-sections text-document may be generated via a User Interface, such as summary configuration UI 105a in FIG. 1A and such as summary configuration UI 105b in FIG. 1B that may be associated to a summary configuration service, such as summary configuration service 115a in FIG. 1A and such as summary configuration service 115b in FIG. 1B. The rule may be generated by a user selection of required sections from the multiple-sections text-document in the text-summary, the length of each section summary, recipients of the text-summary and the like. The UI may be for example, as shown in FIG. 10.

According to some embodiments of the present disclosure, the summary configuration UI may call a REST API endpoint of summary configuration service, such as summary configuration service 115a in FIG. 1A and such as summary configuration service 115b in FIG. 1B to save the configuration, in the summary configuration database, such as summary configuration database 125a in FIG. 1A and such as summary configuration database 125b in FIG. 1B.

According to some embodiments of the present disclosure, the data structure of the summary configuration may be for example the following JavaScript Object Notation (JSON) format, which includes details, such as, the tenant ID, summary level (Agent), summary type (Summarize Single Evaluation or Summarize Multiple Evaluation), and specific guidelines for summarizing different sections, such as Evaluation Summary and Interaction Summary. The summary for Strengths & Improvements, Training Recommendations, and Evaluator's Suggestions and their applicable lengths 5, 3, and 3 points, respectively. Recipients of the evaluation include the Agent, Direct Manager, and Matrix Manager. The schedule of the summary, such as Weekly, Monthly, Quarterly and the like. The preferred format for the generated summary is PDF.

According to some embodiments of the present disclosure, the data structure of the summary configuration may be for example,

```
{
“tenant_Id”: “02fddf29-dccf-47ce-8a3d-b6ba1de8aed8”,
“level”: “Agent”,
“summary_type”: “Summarize Single Evaluation”,
“summary_section”: [
{
  “section”: “Evaluation Summary”,
  “length”: “Medium - 5 lines”
  },{
“section”: “Interaction Summary”,
“length”: “ Short - 3 lines ”
},{
“section”: “Stength & Improvements”,
“length”: 5
  },{
“section”: “Training Recommendation”,
“length”: 3
},{
“section”: “Evaluator's Suggestion”,
“length”: 3
  }
],
“Recipients”: [
“Agent”,
“Direct Manager”,
  “Matrix Manager”
],
“Schedule”: “Monthly”,
“Sent As”: “PDF”
}
```

According to some embodiments of the present disclosure, the rule of configuration may define what sections in the multiple-sections text-document needs to be added in the summary and their length, the number of strength and areas of improvement for agent, one or more recipients of the text-summary that may receive the evaluation summary and the like, for example, as shown in FIG. 10.

According to some embodiments of the present disclosure, for example, the rule of configuration generation may include select configuration 410a such as summary name and type, summary sections to be included and their length, level and schedule the recipients and the format that the text-summary may be sent as.

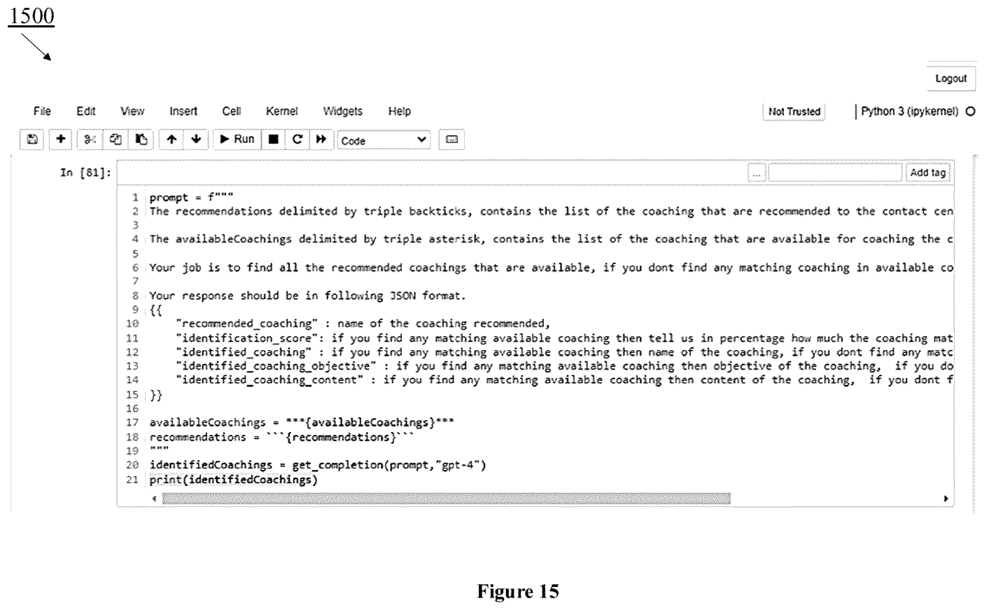

According to some embodiments of the present disclosure, optionally, the mapping of the coaching package that can be automatically distributed to a training recommendation may be preconfigured by a user. The user may select the set of coaching packages from the available coaching packages in the system for auto distribution 420a, such that each coaching package in the set of coaching packages may be configured to be mapped to a training recommendation. Once the evaluation summary is generated, the coaching recommendation in the evaluation summary may be compared with these selected coaching packages, and the matching coaching package may be auto distributed to the agent that is related to the evaluation summary. For example, based on the result of the LLM prompt shown in FIG. 15, where the LLM prompt is asking the LLM prompt executor service, such as LLM prompt executor service 10a in FIG. 1A to look at the recommendation and available coaching and find the match.

According to some embodiments of the present disclosure, optionally, when the user chooses not to auto distribute the coaching packages to the agents, the matched coaching package may be presented to the manager as a coaching recommendation via a UI, and the manager can manually decide to distribute the package, e.g., create a new coaching session with the coaching package.

According to some embodiments of the present disclosure, the data structure of the coaching package details may be for example,

```
{
“Name”: “Dealing with Difficult Customers”,
“Objective”: “To provide agents with strategies for handling challenging customer situations.”,
“Content”: [
  “Staying calm and composed”,
“Active listening and empathy”,
  “Setting boundaries”,
“Offering solutions”,
  “Knowing when to escalate”
  ]
}
```

According to some embodiments of the present disclosure, the rule of configuration may be stored in a database 430a, such as summary configuration database 125a in FIG. 1A and such as summary configuration database 125b in FIG. 1B.

FIG. 4B schematically illustrates high-level flowchart 400B of generating a summary of single evaluation in generating a text-summary of a multiple-sections text-document that was created via an application that is running in a cloud-based Contact Center for a tenant, in accordance with some embodiments of the present invention.

According to some embodiments of the present disclosure, the evaluation summary of the agent can be generated based upon a single evaluation that has been filled out by the evaluator. Fetch evaluation details 410b from section, questions, answers, comments, and history may be operated by fetching data that is related to the multiple-sections text-document from a database of the application, such as database 160a in FIG. 1A. The data related to the multiple-sections text-document may include one or more sections, and each section of the one or more sections may include one or more questions. Each question of the one or more questions has a corresponding answer.

According to some embodiments of the present disclosure, the fetching of the evaluation details 410b may be operated by a summary generator module, such as summary generator module 122a in FIG. 1A of evaluation summarizer module service, such as evaluation summarizer service 120a in FIG. 1A which may fetch evaluation details from the application database, such as database 160a in FIG. 1A.

According to some embodiments of the present disclosure, the data related to the multiple-sections text-document may include evaluation details that have important insights about the agent's performance in the interaction, and thus are used for generating the evaluation summary. The details may include for example, a. sections in the evaluation form: form sections are the collection of questions and section can have titles. E.g., all the question which evaluates how agent followed the call opening protocols can be grouped into one section and title of the section can be “Call Opening Protocol.” b. Questions in the evaluation form:—form questions can be of multiple types such as, Yes/No, Checkbox, Radio Button, Multichoice, Single choice, text etc. The questions are answered by the evaluator in the process of evaluation. c. Answers to the questions in the evaluation form:—This denotes the answers selected after reviewing the interaction (Interaction can be email, voice, chat. Digital etc.) recording by the evaluators. and d. Form comments that include the comments added by the evaluator during the evaluation submission.

According to some embodiments of the present disclosure, the data structure of the evaluation details may be for example,

```
{
“sections”: [{
“section_text”: “Opening the call.”,
“score”: 30,
“max”: 30,
“questions”: [{
  “question_text”: “Did the agent Greet?”,
  “answer”: “Yes”
  },{
  “question_text”: “Was the agent polite?”,
“answer”: “No”,
“evaluator_comment”: “As per my observation this agent's politeness degrades if he works for
continues 3-4 hours. Please consider including small breaks in his schedule.”
},{
  “question_text”: “The agent used proper greeting? The agent:”,
“answer”: “[“Adhered to the greeting script”, “The call was transferred, the rep didn't adapt their
greeting accordingly”, “Identified themselves to the customer”, “Asked for the caller? name/member
ID”, “Thanked the customer for calling”, “Offered assistance to the caller”]”
  }]
  },{
“section_text”: “Internet Technical Skill.”,
“score”: 20,
  “max”: 25,
“questions”: [{
  “question_text”: “Did the agent asked for the customer modem?”,
    “answer”: “Yes”
  },{
“question_text”: “Did the agent timely suggested applicable troubleshooting steps?”,
“answer”: “[“Agent suggested wrong steps”, “Delay in troubleshooting”]”,
“evaluator_comment”: “Agent should utilize the Netgear Modem knowledge base to improve
troubleshooting skills.”
},{
“question_text”: “Call Flow Adherence Skill Assessment”,
“answer”: “Need Improvement.”
}]
},{
“section_text”: “Call handling.”,
“score”: 12,
  “max”: 15,
“questions”: [{
“question_text”: “Appropriate use of hold. Agent placed EE/Caller on hold to research/take action.”,
  “answer”: “Yes”,
“evaluator_comment”: “This interaction is a good example of appropriate usage of hold. Can be
included in future coaching.”
  },{
“question_text”: “Did the agent tried to sale any other product/service upgrades?”,
“answer”: “Partially Explained”,
“evaluator_comment”: “Agent should have taken consent before explaining the benefits, customer
was in hurry and didn't pay attention.”,
  “AgentAppealComment”: “I think, I explained all the required benefits of product.”,
“AppealResolverComment”: “You did not explain the flexible payment plan.”
  }]
  },{
“section_text”: “Call resolution.”,
“score”: 25,
“max”: 30,
“questions”: [{
“question_text”: “Was the agent clear about the solution / gave caller all of their options?”,
  “answer”: “[“Partially clear about solution”, “Resolved the issue”]”
  },{
  “question_text”: “The engineer ensured that the customer comprehended the resolution provided”,
“answer”: “Ensured.”
  },{
    “question_text”: “The engineer's line of questioning was logical and in context with information
customer provided”,
“answer”: “Yes”
    }]
    },{
“section_text”: “Closing the call.”,
“score”: 10,
  “max”: 40,
“questions”: [{
  “question_text”: “The agent did used proper closing protocol. The agent:”,
  “answer”: “[“Was not able to close the call properly”]”,
“evaluator_comment”: “The agent should have stopped the 1st time customer shown hurry. Agent
should have scheduled the callback.”
    },{
  “question_text”: “The agent performed the required documentation?”,
  “answer”: “Did not shared product brochure.”
    },{
“question_text”: “Demographics”,
  “answer”: “Partially Met”,
“AgentAppealComment”: “I did not understand why demographics is applicable.”,
“AppealResolverComment”: “Agreed.”
}]
}],
“history”: [{
“date”: “13-Mar-2023”,
  “user”: “Andrew Scott”,
“userType”: “Evaluator”,
“status”: “Submitted”,
  “score”:86
  },{
“date”: “20-Mar-2023”,
“user”: “Tahir Tam”,
  “userType”: “Agent”,
    ”status”: “Appealed”
    “score”:90
    },{
  “date”: “23-Mar-2023”,
  “user”: “Amir Cohen”,
  “userType”: “Appeal Resolver”,
“status”: “Approved Appeal”
  “score”:90
}]
}
```

According to some embodiments of the present disclosure, fetch summary configuration 420b may be executed by summary generator module, such as summary generator module 122a in FIG. 1A of evaluation summarizer module service, such as evaluation summarizer service 120a in FIG. 1A which may fetch the rule of configuration from the summary configuration service, such as summary configuration service 115a in FIG. 1A which internally runs a database SQL query to summary database, such as summary database 130a in FIG. 1A.

According to some embodiments of the present disclosure, when the tenant has custom summary configuration saved, then those configurations will be utilized 425b to create the prompts otherwise default tenant configuration rules 430b may be utilized to generate the evaluation summary.

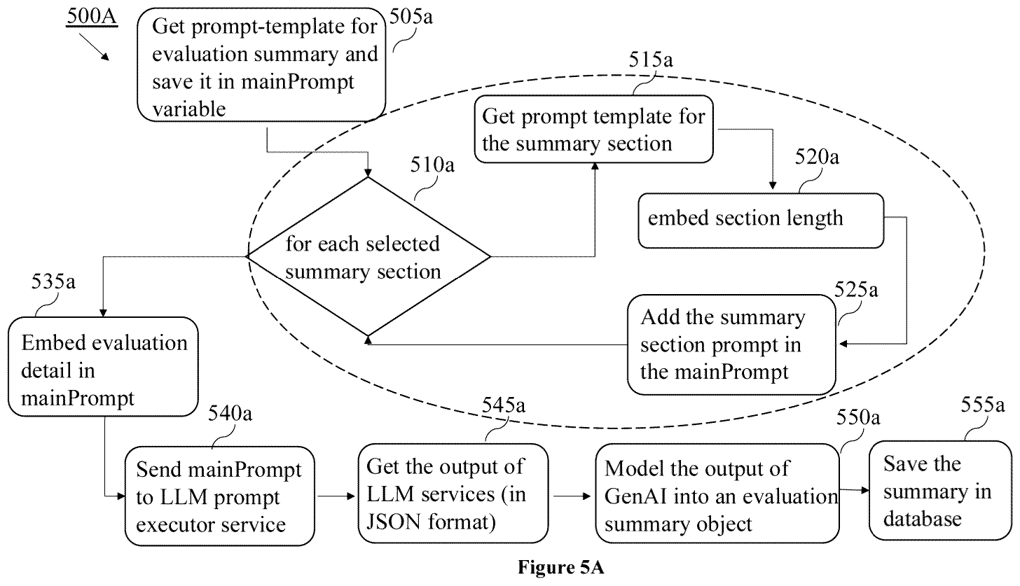

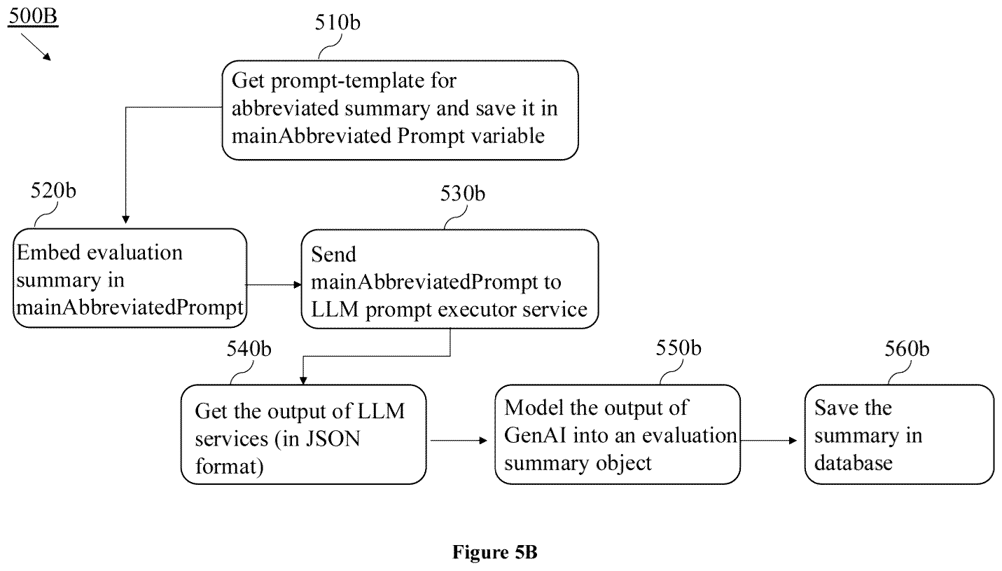

According to some embodiments of the present disclosure, to generate evaluation summary 440b LLM prompt and execution may be operated, as shown in FIGS. 5A-5B.

According to some embodiments of the present disclosure, generate detailed evaluation summary by creating LLM prompt and executing it 450b may be operated to generate an extract of the text-summary by operating the GenAI with LLMs service to execute an abbreviation-prompt with the text-summary to yield the abbreviated-text-summary.

According to some embodiments of the present disclosure, the abbreviated-text-summary may be stored in the summary-database 460b. The abbreviated-text-summary may be used by a scheduler module that may be operated to generate a periodic-text-summary between the period of time.

FIG. 4C schematically illustrates high-level flowchart 400C of generating a summary of multiple evaluations in generating a text-summary of a multiple-sections text-document that was created via an application that is running in a cloud-based Contact Center for a tenant, in accordance with some embodiments of the present invention;

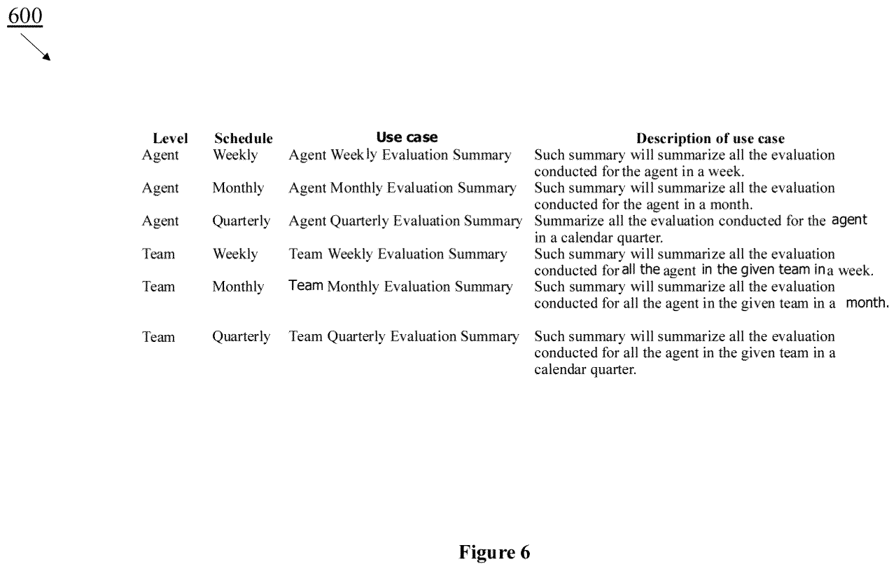

According to some embodiments of the present disclosure, when fetching summary configuration 410c, the summary of multiple evaluations may be generated when the rule of configuration includes summary type of summarize multiple evaluations. Based on the combination of the “Level” and “Schedule” settings in the rule of configuration, various text-summaries may be generated, for example, as shown in FIG. 6. The level may be agent, team of agents and a unit of teams of agents. The schedule may be the period of time that the text-summary may include, such as weekly, monthly, quarterly, yearly and the like.

According to some embodiments of the present disclosure, fetch the applicable detailed evaluation summaries, as per the level and schedule 420c may be executed by the summary generation module, such as summary generator 167b in FIG. 1B of scheduled summarizer service, such as scheduled summarizer service 165b in FIG. 1B.

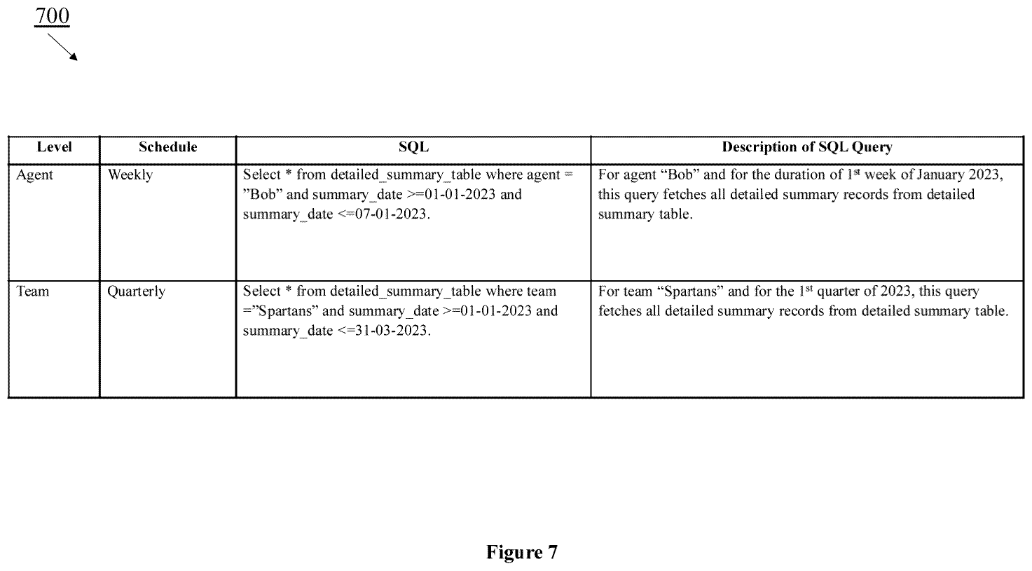

According to some embodiments of the present disclosure, the summary configuration is fetched from REST API of summary configuration service, such as summary configuration service 115b, in FIG. 1B. An SQL query may be built by using the level and schedule property to collect the abbreviated-text-summary from the summary database, such as summary database 130b in FIG. 1B. For example, as shown in FIG. 7

According to some embodiments of the present disclosure, generate summary of multiple evaluation forms by creating LLM prompt based on the abbreviated-text-summary and then executing it 430c. A periodic-text-summary may be generated by operating the GenAI with LLMS service to execute a periodic-prompt-text.

According to some embodiments of the present disclosure, the purpose of the abbreviated-text-summary and the utilization of it is to generate summary of multiple evaluations is to efficiently utilize the token limit supported as per the cloud LLM service-provider. The original text-summary object is a large text object, thus a limited number text-summary objects can be embedded in the prompt-text, as the token size supported by the cloud LLM service-provider is limited. Thus, by creating an abbreviated-text summary of each of each text-summary, may create relatively less amount of text compared to original text-summary object. The abbreviated-text-summary allows to embed more objects inside the prompt-text, resulting into less token consumption, thus improving efficiency in terms of Cloud LLM service-provider cost.

According to some embodiments of the present disclosure, optionally, the text-summary of multiple evaluations may be generated based on the original text-summary objects instead of the abbreviated-text-summary.

According to some embodiments of the present disclosure, the summary may be stored in a database 440c. The periodic-text-summary may be stored in the summary-database, such as summary database 130b in FIG. 1B, to be used to operate the one or more actions.

According to some embodiments of the present disclosure, checking if the summary configuration, e.g., the rule of configuration of the text-summary of the multiple-sections text-document, have recipients 450c. If the summary configuration has recipients, sending the summary, e.g., the periodic-text-summary to the recipients 460c. The text-summary, e.g., periodic-text-summary may be sent via one or more delivery channels by operating a notification delivery service.

According to some embodiments of the present disclosure, the notification delivery service, such as notification delivery service 135b in FIG. 1B may be implemented as a micro service that exposes REST APIs that allow delivery of notifications via various delivery channels, such as in application notification, email, and Short Message Service (SMS) and may be using Java Spring Boot technology, or any other service that offers ability to send notification via email.

According to some embodiments of the present disclosure, optionally, when the summary rule is configured to launch coaching packages to the agents, triggering auto coaching distribution flow 470c.

FIG. 4D schematically illustrates high-level flowchart 400D of auto distribution of a coaching package based on evaluation summary in generate summary of multiple evaluation in generating a text-summary of a multiple-sections text-document that was created via an application that is running in a cloud-based Contact Center for a tenant, in accordance with some embodiments of the present invention;

According to some embodiments of the present disclosure, the auto distribution of a coaching package, e.g., creating a new coaching session to the agent may be triggered for example, when a summary of multiple evaluation forms is generated, as shown in FIG. 4C. The automated coaching distribution module of the coaching application may be configured to execute the auto distribution of the coaching package.

According to some embodiments of the present disclosure, optionally, the auto distribution of the coaching package may be triggered when a text-summary of a single evaluation form is generated, as shown in FIG. 4B. However, when there are approximately ten to fifteen evaluations for an agent per month it may not be recommended to assign a coaching session after each evaluation summary. Also, the coaching recommendations may be more accurate when multiple evaluation forms are analyzed.

According to some embodiments of the present disclosure, finding the available application coaching may be operated by fetching coaching distribution settings 410d. The distribution settings have been configured as shown in FIG. 4A and may include the list of coaching packages that can be auto distributed. The list may be saved inside a temporary variable named “availableCoachings”. Then, from the text-summary, get the coaching recommendations section 420d and save them inside a temporary variable named as “recommendations”.

According to some embodiments of the present disclosure, search for applicable coaching content and create LLM prompt and execute it 430d. The template, for example, as shown in FIG. 15, can be saved inside the code base of the prompt generator module, or it can also be saved inside a text file locally available to the prompt generator module.

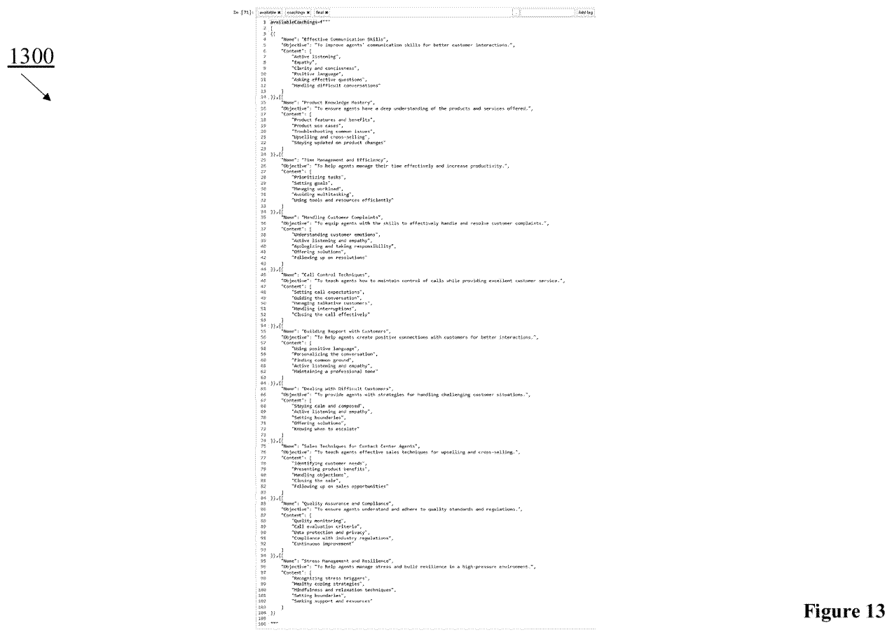

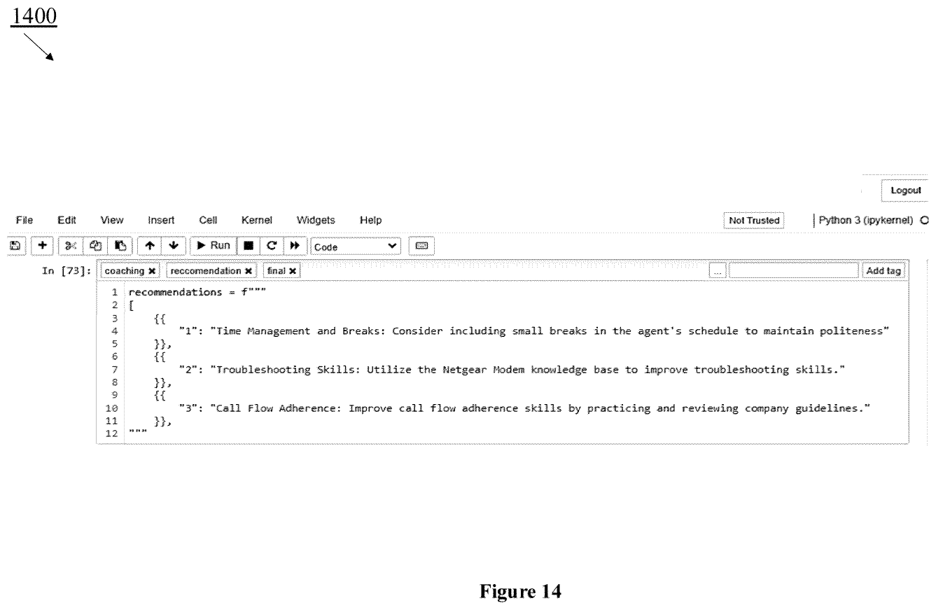

According to some embodiments of the present disclosure, the created LLM prompt template may be saved in a temporary variable named as “mainCoachingPrompt”. The value of “availableCoachings” variable and “recommendations” variable may be embedded in the mainCoachingPrompt. The “availableCoachings” and “recommendations” variables were created as part of the generation of the rule of configuration, shown in FIG. 4A. For example, the “availableCoachings” variable may be as shown in FIG. 13. For example, the “recommendations” variable may be as shown in FIG. 14. For example, the mainCoachingPrompt variable may be as shown in FIG. 15 and named “identfiedCoaching”.

According to some embodiments of the present disclosure, the “mainCoachingPrompt” may be sent to the LLM Prompt executor service, such as LLM prompt executor service 140a in FIG. 1A and such as LLM prompt executor service 140b in FIG. 1B, for execution. The LLM prompt executor service may expose REST endpoint to allow the LLM prompt execution. Once the LLM Prompt execution service returns the output, which is the list of recommended coaching and their identified applicable coaching packages, the response of the LLM prompt may be for the first and second recommendations, the available coaching matched and their relevant percentage match score is 60% and 80%, whereas, for the third recommendation, there is no coaching available, thus the score is 0%. for example, as in the following data structure:

[
{
“recommended_coaching”: “Time Management and Breaks”,
“identification_score”: “60%”,
“identified_coaching”: “Time management and Efficiency”,
“identified_coaching_objective”: “To help agents manage their time effectively and increase
productivity.”,
“identified_coching_content”: [
“Prioritizing tasks”,
“setting goals”,
“Managing workload”,
“Avoiding multitasking”,
“Using tools and resources efficiently”
]
},
{
“recommended_coaching”: “Troubleshooting Skills”,
“identification_score”: “80%”,
“identified_coaching”: “Product knowledge Mastery”,
“identified_coaching_objective”: “To ensure agents have a deep understanding of the products and
services offered.”,
“identified_coching_content”: [
“Product features and benefits”,
“Product use cases”,
“Troubleshooting common issues”,
“Upselling and cross-selling”,
“Staying updated on product changes”,
]
},
{
“recommended_coaching”: “Call flow Adherence”,
“identification_score”: “0%”,
“identified_coaching”: “”,
“identified_coaching_objective”: “”,
“identified_coching_content”: [ ]
}
]

According to some embodiments of the present disclosure, for each recommended coaching, in the response the “identification_score” is received which indicates the percentage of match between recommended coaching and available, higher the value stronger the match. 0% score indicates that there is no match. This score can may be used to in comparison to a score threshold. This list of identified applicable coaching may be saved as “identifiedCoachings” variable, which may be used for the distribution of the coaching packages to the agents.

According to some embodiments of the present disclosure, when checking if applicable coaching is available 440d and there is no applicable coaching available, that is, when the “identification_score” is less than a score threshold e.g., 50%, it may be considered that the available coaching is not a good match for the recommended coaching. Thus, the coaching package may not be distributed, and the recommended coaching may be stored in the coaching application, which are shown to the coach 455d via the UI of the application. The recommended coaching may be shown so that the coach would know that there are coaching needs for which there is no applicable coaching package. The coach may manually create coaching packages and send them to appropriate agents from the text-summary.

According to some embodiments of the present disclosure, when checking if applicable coaching 440d is available, and there is applicable coaching available, that is, when the “idendification_score” is above the score threshold, e.g., 50%, then the coaching packages may be distributed 450d. The distribution of the coaching packages may be operated by performing the following for each identified coaching package. Finding agents that for whom the coaching recommendation was generated in the text-summary and distributing the coaching package to the agent.

FIG. 5A schematically illustrates high-level flowchart 500A of creating prompt and executing an evaluation summary, in accordance with some embodiments of the present invention.

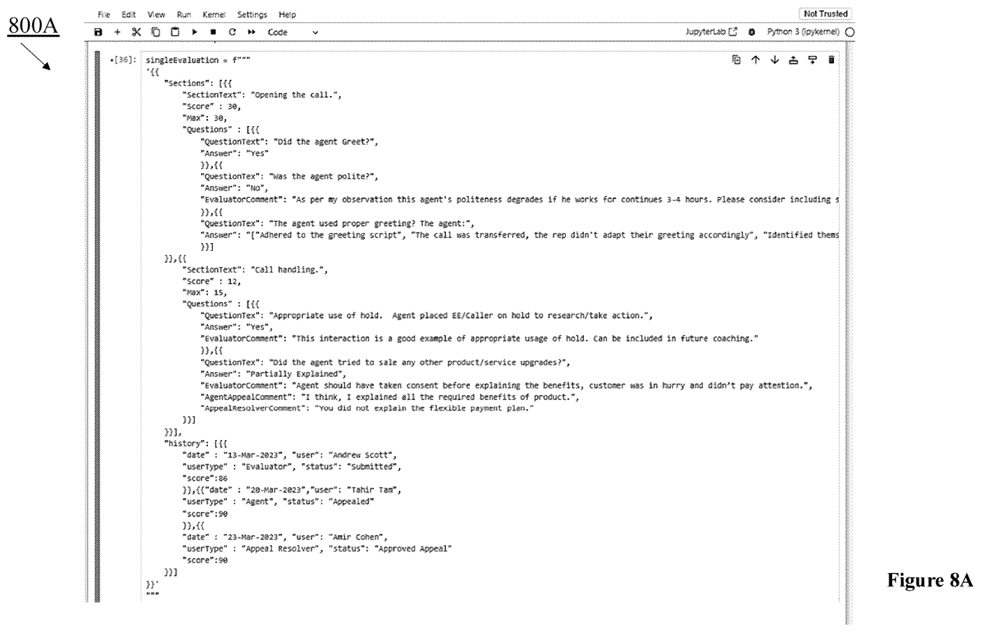

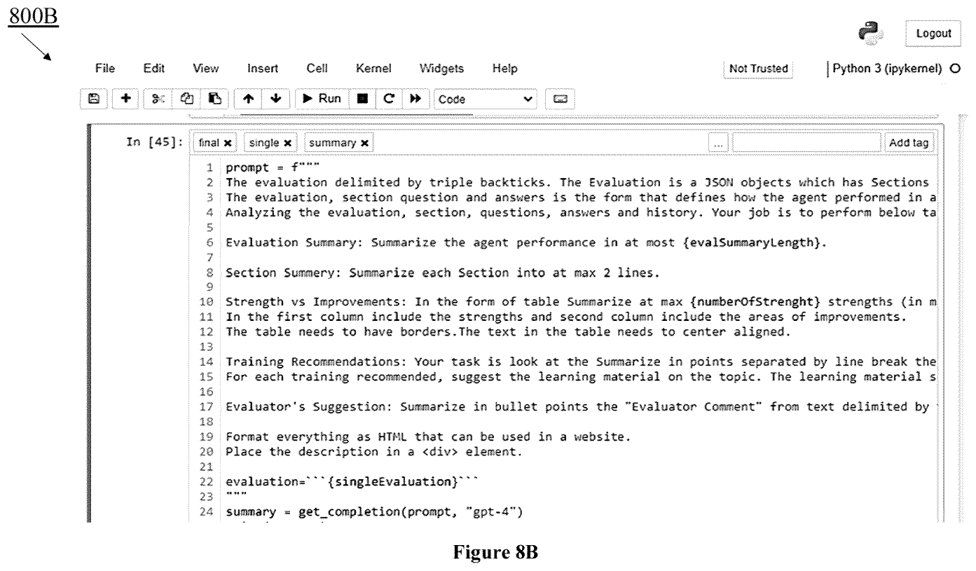

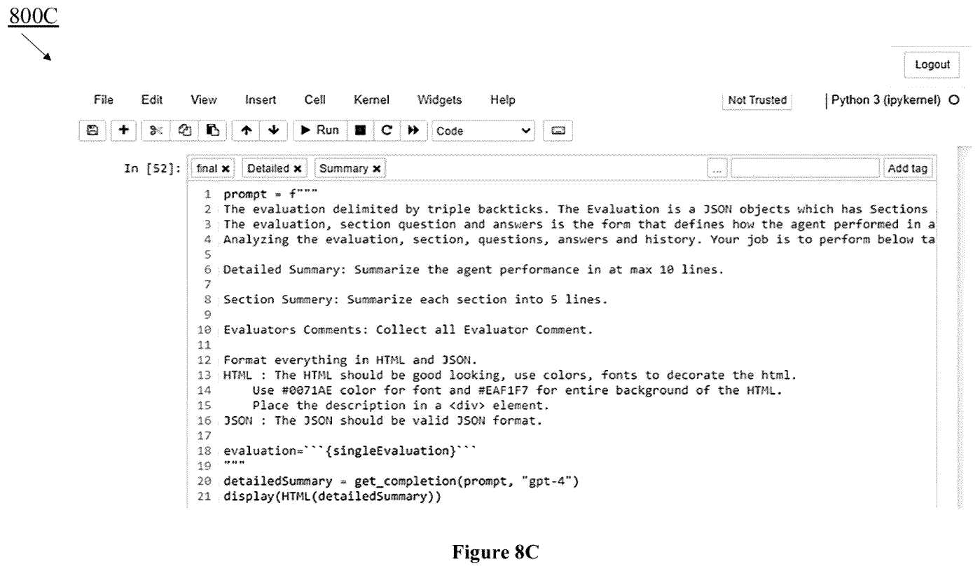

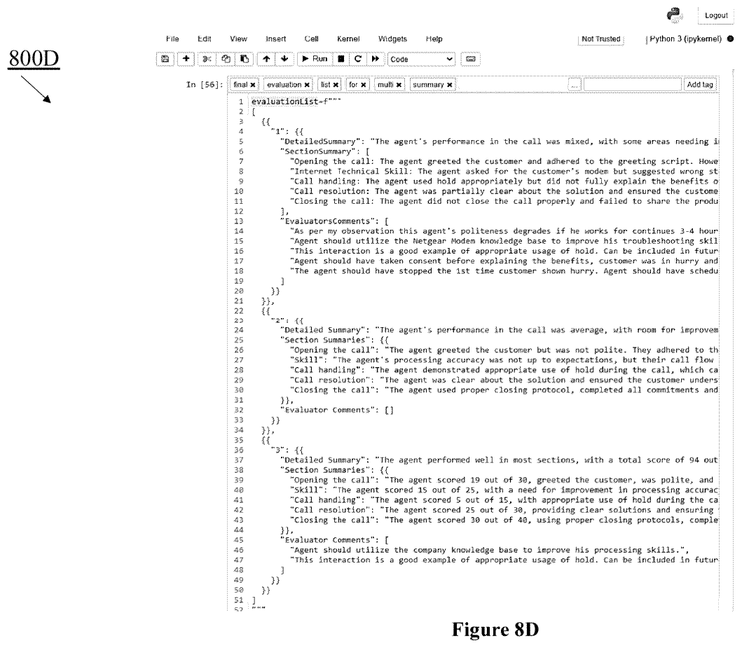

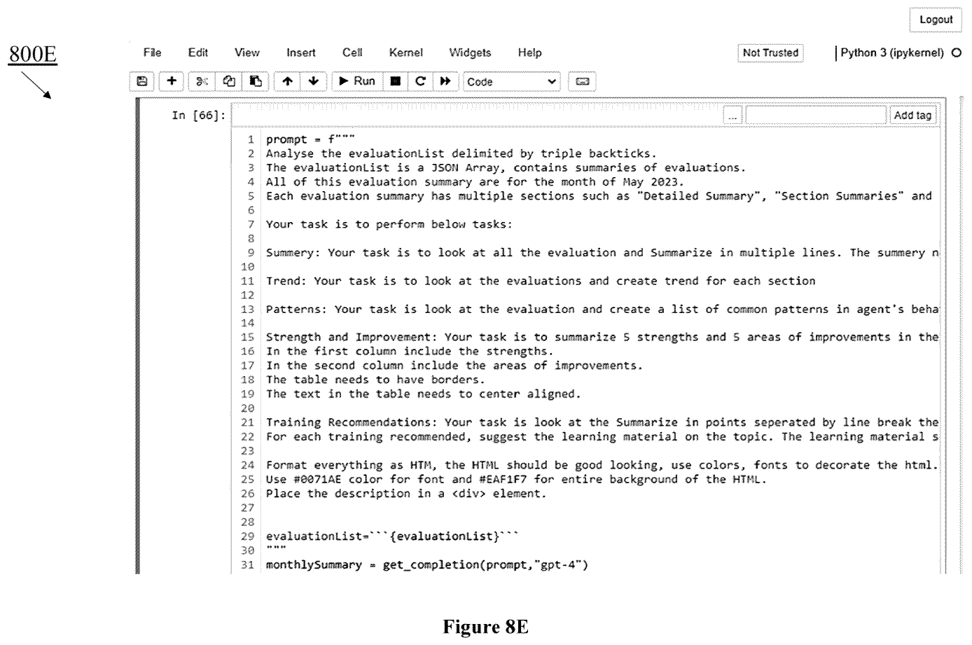

According to some embodiments of the present disclosure, an evaluation summary, e.g., text-prompt may be generated by an evaluation summarizer service, such as evaluation summarizer service 120a in FIG. 1B and such as evaluation summarizer service 120b in FIG. 1B. Get prompt-template for evaluation summary and save it in mainPrompt variable 505a. For example, as shown in FIG. 8B. The template may be saved inside the code base of the prompt generator module, such as prompt generator module 121a in FIG. 1A and such as prompt generator module 121b in FIG. 1B or it can also be saved inside a text file locally available to the prompt generator module. The mainPrompt variable may be a temporary variable.

According to some embodiments of the present disclosure, the evaluation summarizer service, such as evaluation summarizer service 120a in FIG. 1A and such as evaluation summarizer service 120b in FIG. 1B may use the summary configuration, such as the rule of configuration of the text-summary of the multiple-sections text-document and operate for each selected summary section 510a, as shown in the rule, the following operations: get prompt template for the summary section 515a, embed section length 520a based on the length in the rule of configuration and add the summary section prompt in the mainPrompt 525a. operations 510a-525a may be performed to all the selected summary sections in the rule of configuration, such that at the end of it mainPrompt variable may have all the configured summary sections and their related length.

According to some embodiments of the present disclosure, the rule of configuration of the text-summary of the multiple-sections text-document may be save as a JSON object. For example, the configuration of the evaluation summary may include details, such as the tenant ID, summary level (Agent), summary type (Summarize Single Evaluation or Summarize Multiple Evaluation), and specific guidelines for summarizing different sections, such as Evaluation Summary and Interaction Summary. The summary for Strengths & Improvements, Training Recommendations, and Evaluator's Suggestions and their applicable lengths 5, 3, and 3 points, respectively. Recipients of the evaluation include the Agent, Direct Manager, and Matrix Manager. The schedule of the summary, such as Weekly, Monthly, Quarterly etc. The preferred format for the generated summary is PDF.

```
{
“tenant_Id”: “02fddf29-dccf-47ce-8a3d-b6ba1de8aed8”,
“level”: “Agent”,
“summary_type”: “Summarize Single Evaluation”,
  “summary_section”: [
  {
“section”: “Evaluation Summary”,
“length”: “Medium - 5 lines”
},{
“section”: “Interaction Summary”,
“length”: “ Short - 3 lines ”
},{
“section”: “Stength & Improvements”,
“length”: 5
},{
“section”: “Training Recommendation”,
“length”: 3
  },{
“section”: “Evaluator's Suggestion”,
“length”: 3
  }
],
“Recipients”: [
“Agent”,
“Direct Manager”,
“Matrix Manager”
],
“Schedule”: “Monthly”,
  “Sent As”: “PDF”
}
```

According to some embodiments of the present disclosure, the evaluation summarizer service, such as evaluation summarizer service 120a in FIG. 1A and such as evaluation summarizer service 120b in FIG. 1B may embed evaluation detail in mainPrompt 535a, that is embed the details of the evaluation form in the mainPrompt variable. Then, when the mainPrompt variable is ready for execution, the evaluation summarizer service may send mainPrompt to LLM prompt executor service 540a, such as LLM prompt executor service 140a in FIG. 1A and such as LLM prompt executor service 140b in FIG. 1B.

According to some embodiments of the present disclosure, the LLM prompt service may expose REST endpoint to allow the execution of the LLM prompt e.g., mainPrompt variable. Once the LLM prompt execution service returns the output, which is the generated summary, e.g., text-summary for example, in the JSON format. Get the output of the LLM service 545a and model the output of GenAI into an evaluation summary object 550a. The evaluation summary object structure may capture the key information such as evaluation summary, training recommendations and evaluator suggestions. For example,

```
{
  “evaluation_summary”: “The agent scored 90 out of 100 after the appeal. They performed well in
opening the call, internet technical skills, and call resolution. However, they need improvement in
call handling and closing the call.”,
  “section_summary”: [
    “Opening the call: Agent greeted and followed the script but lacked politeness.”,
    “Internet Technical Skill: Agent asked for modem but had delays and wrong steps in
troubleshooting.”,
    “Call handling: Agent used hold appropriately but didn't fully explain product benefits.”,
    “Call resolution: Agent was partially clear about the solution and ensured customer
comprehension.”,
    “Closing the call: Agent struggled with closing protocol and documentation.”
  ],
  “strengths”: [
    “Solid call flow adherence”,
    “Appropriate use of hold”,
    “Clear solutions provided”,
    “Ensured customer comprehension”,
    “Proper closing protocol followed.”
  ],
  “improvements”: [
    “Politeness”,
    “Processing accuracy”,
    “Informing client of appointment details”
  ],
  “training_recommendations”: [
    {
      “topic”: “Politeness and Empathy”,
      “resource_link”: “https://www.callcentrehelper.com/10-tips-for-improving-customer-empathy-
155.htm”
    },
    {
      “topic”: “Troubleshooting Skills”,
      “resource_link”: “https://www.udemy.com/topic/troubleshooting/”
    },
    {
      “topic”: “Call Handling and Closing”,
      “resource_link”: “https://www.callcentrehelper.com/50-call-centre-training-tips-155.htm”
    }
  ],
  “EvaluatorSuggestions”: [
    “Include small breaks in the agent's schedule to maintain politeness.”,
    “Utilize the Netgear Modem knowledge base to improve troubleshooting skills.”,
    “Include this interaction as an example of appropriate hold usage in future coaching.”,
    “Take consent before explaining product benefits, especially when the customer is in a hurry.”,
    “Schedule a callback when the customer shows hurry and is unable to properly close the call.”
  ]
}
```

According to some embodiments of the present disclosure, the generated evaluation summary object may be stored in a database 555a, such as summary database 130a in FIG. 1A and such as summary database 130b in FIG. 1B.

FIG. 5B schematically illustrates high-level flowchart 500B of creating prompt and executing an abbreviated evaluation summary, in accordance with some embodiments of the present invention.

According to some embodiments of the present disclosure, the evaluation summarizer service, such as evaluation summarizer service 120a in FIG. 1B and such as evaluation summarizer service 120b in FIG. 1B may operate the prompt generator module, such as prompt generator module 121a in FIG. 1A and such as prompt generator module 121b in FIG. 1B to get prompt-template for abbreviated summary and save it in mainAbbreviated prompt variable 510b, as shown in FIG. 8C.

According to some embodiments of the present disclosure, the template may be saved inside the code base of the prompt generator module, or it can also be saved inside a text file locally available to the prompt generator module.

According to some embodiments of the present disclosure, the summary generator module, such as summary generator module 122a in FIG. 1A and such as summary generator module 122b in FIG. 1B may embed the evaluation summary or the data related to the multiple-sections text-document and the multiple-sections text-document in mainAbbreviatedPrompt 520b and then, send the mainAbbreviatedPrompt to the LLM prompt executor service, such as LLM prompt executor service 140a in FIG. 1A and such as LLM prompt executor service 140b in FIG. 1B, for execution.

According to some embodiments of the present disclosure, once the LLM prompt executor service returns the output, which is the generated abbreviated evaluation summary for example, in JSON format, get the output of LLM services 540b, the output may be modeled into an evaluation summary object 550b, and then saved in a database 560b, such as summary database 130a in FIG. 1A and such as summary database 130b in FIG. 1B. The output may include summary, section summaries, and evaluator's comments for the agent's performance evaluation.

According to some embodiments of the present disclosure, for example the abbreviated summary object structure may be:

{
“detailed_summary”: “The agent's performance in the call was mixed, with some areas needing
improvement. They scored 30/30 in opening the call, 20/25 in internet technical skill, 12/15 in call
handling, 25/30 in call resolution, and 10/40 in closing the call. The agent was polite, but their
politeness degraded after working for 3-4 hours continuously. They also struggled with
troubleshooting steps and closing the call properly.”,
“section_summary”: [
“Opening the call: The agent greeted the customer and adhered to the greeting script. However, they
were not consistently polite throughout the call.”,
“Internet Technical Skill: The agent asked for the customer's modem but suggested wrong steps and
had a delay in troubleshooting. They need to improve their call flow adherence skills.”,
“Call handling: The agent used hold appropriately but did not fully explain the benefits of a
product/service upgrade.”,
“Call resolution: The agent was partially clear about the solution and ensured the customer understood
the resolution provided. Their line of questioning was logical and in context.”,
“Closing the call: The agent did not close the call properly and failed to share the product brochure.
Demographics were partially met.”
],
“evaluator_comments”: [
“As per my observation this agent's politeness degrades if he works for continues 3-4 hours. Please
consider including small breaks in the schedule.”,
“Agent should utilize the Netgear Modem knowledge base to improve troubleshooting skills.”,
“This interaction is a good example of appropriate usage of hold. Can be included in future
coaching.”,
“Agent should have taken consent before explaining the benefits, customer was in a hurry and didn't
pay attention.”,
“The agent should have stopped the 1st time customer shown hurry. Agent should have scheduled the
callback.”
]
}

According to some embodiments of the present disclosure, the purpose of constructing the abbreviated summary is to efficiently utilize the token limit that is supported as by the cloud LLM model provider. The construction of the abbreviated summary may be optional such that the original evaluation summary may be to generate the evaluation summery of multiple evaluations.

FIG. 8A is an example 800A of details of an evaluation LLM prompt, in accordance with some embodiments of the present invention.

According to some embodiments of the present disclosure, the details of the evaluation form may be stored in a temporary variable, for example, the variable named “singleEvaluation”. The variable may be used to embed the evaluation details within the LLM prompt.

FIG. 8B is an example 800B of summary of a single evaluation LLM prompt, in accordance with some embodiments of the present invention. According to some embodiments of the present disclosure,

According to some embodiments of the present disclosure, the details of evaluation form which are in the temporary variable, as shown in FIG. 8A, may be embedded in the LLM prompt that may be executed by sending the LLM prompt to GenAI with LLM service of a cloud GenAI with LLM service-provider. The executed LLM prompt may result, for example, in a summary, as shown in FIG. 9.

FIG. 8C is an example 800C of abbreviated summary of a single evaluation LLM prompt, in accordance with some embodiments of the present invention.

According to some embodiments of the present disclosure, the details of evaluation form which are in the temporary variable, as shown in FIG. 8A, may be embedded in the abbreviated summary of a single evaluation LLM prompt that may be executed by sending the LLM prompt to GenAI with LLM service of a cloud GenAI with LLM service-provider. The executed LLM prompt may result, for example, in a summary, as shown in FIG. 10.

FIG. 8D is an example 800D of a summary of multiple evaluation LLM prompt, in accordance with some embodiments of the present invention.

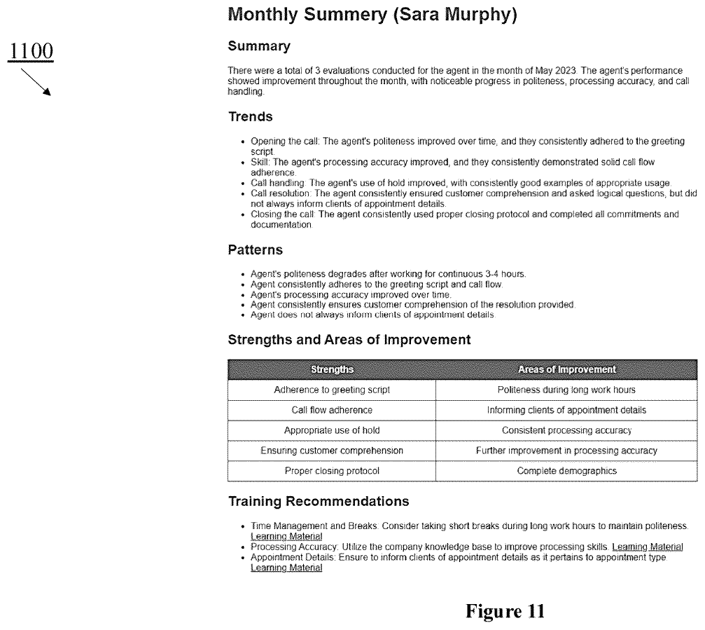

According to some embodiments of the present disclosure, all the in the abbreviated-text-summary objects related to the entity, may be embedded in an LLM prompt, and then the LLM prompt may be embedded in a prompt, such as prompt 800E, in FIG. 8E, which then may be executed by sending the LLM prompt to GenAI with LLM service of a cloud GenAI with LLM service-provider. The executed LLM prompt may result, for example, in a summary, as shown in FIG. 11.

FIG. 12 is an example of a User Interface (UI) 1200 for summary configuration, in accordance with some embodiments of the present invention.

According to some embodiments of the present disclosure, UI 1200 is an example of user input to generate summary for each evaluation. Thus, the user has selected the summary type as “Summarize Single Evaluation” and named it as “Full Summary Each Evaluation”. In the required summary, the user wanted to include all section, thus all available sections have been selected from the options. The required length has been configured. For example, the user selected to generate at most five strength and areas of Improvements, at most three training recommendations and at most 3 evaluator suggestions. The user wanted to send this summary in the form of notification with the application, text email including PDF, thus selected all required options in sent as field. Also, the user wanted to send this summary to the agent and agent's manager, thus selected appropriate options in the recipients field.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for generating a text-summary of a multiple-sections text-document that was created via an application that is running in a cloud-based Contact Center (CC) for a tenant, said computerized-method comprising:
(i) operating a prompt-generator module to yield a prompt-text, said prompt-generator module comprising:
a. retrieving a rule of configuration of the text-summary of the multiple-sections text-document, from a summary-configuration database;
b. fetching data related to the multiple-sections text-document from a database of the application,
wherein the data related to the multiple-sections text-document comprising one or more sections, and
wherein each section of the one or more sections comprising one or more questions and each question of the one or more questions has a corresponding answer; and
c. generating the prompt-text based on the rule of configuration and the data related to the multiple-sections text-document and the multiple-sections text-document;
(ii) generating the text-summary by operating a Generative Artificial Intelligence (GenAI) with Large Language Models (LLMs) service of a cloud GenAI with LLM service-provider to execute the prompt-text; and
(iii) storing the text-summary in a summary-database to be used to operate one or more actions for the tenant.

2. The computerized-method of claim 1, wherein said generating of the text-summary of the multiple-sections text-document is operated upon receiving from a serverless streaming data service, a trigger event of completion of filling out the multiple-sections text-document.

3. The computerized-method of claim 1, wherein the rule is one of: (i) default summary configuration; and (ii) tenant summary configuration.

4. The computerized-method of claim 1, wherein the rule of configuration of the text-summary comprising at least one of: (i) required features in the multiple-sections text-document; (ii) length of each section; (iii) one or more recipients of the text-summary; (iv) number of multiple-sections text-documents included in the text-summary; and (v) format in which the text-summary is sent to the one or more recipients, and wherein said prompt-generator module is generating the prompt-text based on the required features in the multiple-sections text-document by embedding each feature in a prompt-template.

5. The computerized-method of claim 4, wherein the text-summary is an evaluation summary and the multiple-sections text-document is an evaluation form of performance of an agent during an interaction with a customer, and wherein the evaluation form has been created via a Quality Management (QM) application that is running as a service via the cloud-based CC for the tenant, and wherein the database is a QM database that is associated to the QM application.

6. The computerized-method of claim 5, wherein the required features comprising at least one of: (i) length of summary of the text-summary; (ii) length of a summary of an interaction related to the evaluation form; (iii) length of summary of each section of the multiple-sections text-document; (iv) strength and improvements of the agent; (v) trends and patterns demonstrated by the agent in multiple-sections text-documents; (vi) training recommendations; and (vii) summary of suggestions given by an evaluator that filled out the evaluation form.

7. The computerized-method of claim 4, wherein said prompt-generator module is generating the prompt-text based on the required features in the multiple-sections text-document by embedding each feature in the prompt-template.

8. The computerized-method of claim 1, wherein said computerized-method further comprising:
(i) operating a configuration service to receive the rule for configuration of the text-summary from the tenant via a summary configuration User Interface (UI); and (ii) storing the rule for configuration of the text-summary in the summary-configuration database.

9. The computerized-method of claim 4, wherein the multiple-sections text-document is a combination of more than one text-document, wherein the rule for configuration of the text-summary further comprising: (i) multiple text-documents in the combination of more than one text-document; and (ii) related entity of the combination of the more than one text-documents and a period of time thereof, and wherein the related entity is one of: a. agent; b. team of agents; and c. organization unit that includes multiple teams of agents.

10. The computerized-method of claim 9, wherein when the rule for configuration of the text-summary comprising multiple text-documents in the combination of more than one text-document and related entity of the combination of more than one text-document and a period of time, said computerized-method further comprising: (i) generating an extract of the text-summary by operating the GenAI with LLMs service to execute an abbreviation-prompt with the text-summary to yield an abbreviated-text-summary; (ii) storing the abbreviated-text-summary in the summary-database; and (iii) operating a scheduler module to generate a periodic-text-summary between the period of time.

11. The computerized-method of claim 9, wherein when the rule for configuration of the text-summary comprising multiple text-documents in the combination of more than one text-document and related entity of the combination of more than one text-document and a period of time, said computerized-method further comprising: (i) generating an extract of the text-summary by operating the GenAI with LLMs service to execute an abbreviation-prompt with the multiple-sections text-document to yield an abbreviated-text-summary; (ii) storing the abbreviated-text-summary in the summary-database; and (iii) operating a scheduler module to generate a periodic-text-summary between the period of time.

12. The computerized-method of claim 4, wherein an action of the one or more actions that is operated is sending the text-summary via one or more delivery channels by operating a notification delivery service, and wherein the text summary is sent to the one or more recipients of the text-summary.

13. The computerized-method of claim 6, wherein an action of the one or more actions that is operated is running an automated coaching distribution module, said automated coaching distribution module comprising creating a new coaching session to the agent, via a coaching management system, based on the training recommendations in the text-summary.

14. The computerized-method of claim 10, wherein said scheduler module comprising: a. retrieving the rule of configuration of the text-summary of the multiple-sections text-document, from the summary-configuration database, every preconfigured period; when the period of time in the rule has reached b. retrieving one or more abbreviated-text-summaries of the related entity during the period of time from the summary-database; c. generating the periodic-text-summary by operating the GenAI with LLMS service to execute a periodic-prompt-text; and d. storing the periodic-text-summary in the summary-database to be used to operate the one or more actions, and wherein the periodic-prompt-text is generated based on the one or more abbreviated-text-summaries in a periodic-prompt-template.

15. A computerized-system for generating a text-summary of a multiple-sections text-document that was created via an application that is running in a cloud-based Contact Center (CC) for a tenant, said computerized-system comprising:
one or more processors, said one or more processors are configured to:
(i) operate a prompt-generator module to yield a prompt-text, said prompt-generator module comprising:
a. retrieving a rule of configuration of the text-summary of the multiple-sections text-document, from a summary-configuration database;
b. fetching data related to the multiple-sections text-document from a database of the application,
wherein the data related to the multiple-sections text-document comprising one or more sections, and
wherein each section of the one or more sections comprising one or more questions and each question of the one or more questions has a corresponding answer; and
c. generating the prompt-text based on the rule of configuration and the data related to the multiple-sections text-document and the multiple-sections text-document;
(ii) generate the text-summary by operating a Generative Artificial Intelligence (GenAI) with Large Language Models (LLMs) service of a cloud GenAI with LLM service-provider to execute the prompt-text; and
(iii) store the text-summary in a summary-database to be used to operate one or more actions for the tenant.
